(19) United States
(12) Patent Application Publication
(10) Pub. No.: US 2006/0265445 A1
(43) Pub. Date: Nov. 23, 2006

(54) Method and structure for improving processing efficiency in parallel processing machines for rectangular and triangular matrix routines

(75) Inventors: Fred Gehrung Gustavson, Briarcliff Manor, NY (US); John A. Gunnels, Brewster, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/133,254

(22) Filed: May 20, 2005

(51) Int. Cl. G06F 7/32

(52) U.S. Cl. 708/520

(57) ABSTRACT

A computerized method (and structure) of linear algebra processing on a computer having a plurality of processors for parallel processing, includes, for a matrix having elements originally stored in a memory in a rectangular matrix AR or especially of one of a triangular matrix AT format and a symmetric matrix AS format, distributing data of the rectangular AR or triangular or symmetric matrix (AT, AS) from the memory to the plurality of processors in such a manner that keeps all submatrices of AR or substantially only essential data of the triangular matrix AT or symmetric matrix AS is represented in the distributed memories of the processors as contiguous atomic units for the processing. The linear algebra processing done on the processors with distributed memories requires that submatrices be sent and received as contiguous atomic units based on the prescribed block cyclic data layouts of the linear algebra processing. This computerized method (and structure) defines all of its submatrices as these contiguous atomic units, thereby avoiding extra data preparation before each send and after each receive. The essential data or AT or AS is that data of the triangular or symmetric matrix that is minimally necessary for maintaining the full information content of the triangular AT or symmetric matrix AS.

### CROSS-REFERENCE TO RELATED APPLICATIONS

The present application is related to U.S. patent application Ser. No. 11/045,354, filed on Jan. 31, 2005, to Gustavson et al., entitled “METHOD AND STRUCTURE FOR A HYBRID FULL-PACKED STORAGE FORMAT AS A SINGLE RECTANGULAR FORMAT DATA STRUCTURE,” having IBM Docket YOR920050030US1; and

U.S. patent application Ser. No. 10/671,933, filed on Sep. 29, 2003, to Gustavson et al., entitled “METHOD AND STRUCTURE FOR PRODUCING HIGH PERFORMANCE LINEAR ALGEBRA ROUTINES USING A HYBRID FULL-PACKED STORAGE FORMAT,” having IBM Docket YOR920030168US1.

The contents of both of these co-pending applications are incorporated herein by reference.

### BACKGROUND OF THE INVENTION

1. Field of the Invention

The present invention relates generally to improving processing performance for linear algebra routines on parallel processor machines for triangular or symmetric matrices by saving about 100% of the storage (relative to the essential data of a triangular/symmetric matrix) required by conventional methods because, heretofore, the superfluous data inherent to the triangular/symmetric matrix data was carried along as part of the matrix routine. In a first embodiment, the essential triangular matrix data is mapped in contiguous atomic blocks of data onto the processor grid in a direct memory transfer selectively involving only the essential data, and in a second embodiment, a hybrid full-packed data structure provides a rectangular standard row/column major format of atomic blocks of contiguous essential triangular matrix data. Either of these embodiments substantially precludes the superfluous data from being distributed to the processor grid, thereby not only allowing storage reduction but also providing performance improvement, since data is also presented for processing in contiguous atomic blocks most appropriate for the processing being executed, thereby eliminating the repeated data copying, managing, and reformatting of the residual essential data that conventional methods required.

2. Description of the Related Art

Scientific computing relies heavily on linear algebra. In fact, the whole field of engineering and scientific computing takes advantage of linear algebra for computations. Linear algebra routines are also used in games and graphics rendering. Linear algebra is also heavily used in analytic methods that include applications such as supply chain management, as well as numeric data mining and economic methods and models.

The reason that linear algebra is so ubiquitous is that most engineering/scientific problems comprise non-linear scenarios which are combined by modeling as an aggregation of linearized sections, each respectively described by linear equations. Therefore, a linear network is formed that can be described in matrix format. It is noted here that the terms “array” and “matrix” are used interchangeably in the discussion of the present invention.

In general, a matrix representation, A, can be “simplified” by making a plurality of coordinate transformations so that the solution then becomes trivial, or at least easier, to obtain in the final coordinates. Common coordinate transformations include transformation into the identity matrix or into the LU factors format. The “L” signifies lower triangular matrix, and “U” signifies an upper triangular matrix. Matrix A becomes equal to the product of L by U (i.e., LU).

The process of coordinate transformation wherein two coordinate systems are composed into a single coordinate system involves, by definition, matrix multiplication. Hence, the present invention focuses particularly on techniques that will particularly enhance matrix multiplication, but is not so limited. Typically, linear algebra subroutines are stored as standard subroutines in a math library of a computer tool utilizing one or more linear algebra routines as a part of its processing.

A number of methods have been used to improve performance of new or existing computer architectures for linear algebra routines. However, because linear algebra permeates so many applications, a need continues to exist to optimize performance of matrix processing, including the need for efficiency in storing and processing data of triangular/symmetric matrices.

The two above-identified co-pending applications address a problem related to the storage format for array data of triangular/symmetric matrices. Conventionally, there are two primary storage formats for array data: the full format, in which the data is stored in a rectangular space; and the triangular packed format, in which the array data has been converted and stored in triangular space, as shown in FIG. 1.

To explain the problem addressed by the present invention, FIG. 1 shows a generic n by n square matrix 101 and a generic triangular matrix 102 having n rows and n columns. As shown in FIG. 2, if triangular matrix 201 is stored in rectangular memory, there will be n(n−1)/2 spaces of memory that is not used for storing the matrix data (e.g., “superfluous data”).

For purpose of discussion herein, the term “essential data” means the minimal data in a triangular or symmetric matrix that is necessary to maintain its full information content. “Superfluous data”, then, is whatever data also exists in the memory location of a triangular/symmetric matrix other than essential data.

Although these figures show a triangular matrix, it is readily recognized that symmetric matrices, wherein the data is symmetric across the matrix diagonal, will have redundant data on one side of the diagonal. Therefore, for purpose of the present invention, symmetric matrices also have data similarly superfluous, in the same manner corresponding to that of data complementary to a lower or upper triangular matrix. Although much of the following discussion is illustrated with a lower triangular matrix, it should be apparent that the concepts apply equally to upper triangular and symmetric matrices.

The two above-identified co-pending applications addressed the problem of wasted memory space for triangular/symmetric matrices by demonstrating two methods to eliminate the superfluous data by converting the meaningful triangular data (e.g., the “essential data” that minimally conveys the information content of triangular/symmetric matrix data) into a rectangular data structure and modifying the matrix processing routine to accommodate the reformatted data.

The present invention addresses a somewhat analogous problem with triangular matrix processing on machines having a grid of processors interconnected in parallel, wherein each processor in the grid performs a pre-assigned portion of the processing occurring in parallel.

More specifically, as noted, nearly half of triangular/symmetric matrix data stored in conventional methods in a rectangular memory space is “wasted” by reason of being occupied by zeroes, “don't care”, or redundant data. These superfluous data elements are conventionally carried along as data onto the processor grid (e.g., a processor grid of size P×Q) for processing of matrix subroutines, such as the common Cholesky factorization routine, used later as an example to explain an exemplary processing adaptation that is one aspect of the present invention. It is noted that, particularly in the environment of today's parallel-processor machines and the sizes of matrices, the matrix data is typically transferred to each processor in increments of a data block, which is typically, but not necessarily, a square block (e.g., a block of size nb×nb).

Each of the P×Q processors stores data only as a composite rectangular array which, therefore, only holds a rectangular set of blocks of data. So, based on considering that a triangular/symmetric matrix has almost 50% superfluous data elements, every one of the P×Q processors can be considered as having to reserve almost 100% extra storage space, relative to the amount of essential data, for the computation even to proceed. In addition to the extra storage, this data format must be further managed throughout the processing of the algorithm, causing an additional factor in the data processing efficiency and thereby reducing computation performance.

Thus, the present inventors have recognized that a need exists to reduce the extra memory requirements and the efficiency loss inherent in processing triangular/symmetric matrices in parallel machines using the conventional methods in which matrix data is transferred to the P×Q processor grid and processed to execute a linear algebra operation on triangular/symmetric matrix data.

### SUMMARY OF THE INVENTION

In view of the foregoing exemplary problems, drawbacks, and disadvantages of the conventional systems, it is, therefore, an exemplary feature of the present invention to provide a technique that reduces storage for triangular/symmetric matrix data in linear algebra routines executed on parallel-processor machines.

It is another exemplary feature of the present invention to improve the efficiency of triangular/symmetric matrix processing on parallel-processor machines.

It is another exemplary feature of the present invention to present a method of data distribution of triangular/symmetrical matrix data to a rectangular grid of processors of a parallel-processor machine by using atomic blocks of contiguous data in a manner that improves processing efficiency of matrix operations in general, including processing for rectangular matrix data as well as the triangular/symmetrical matrix data.

It is another exemplary feature of the present invention to reduce the amount of data copying done on processors in a parallel-processor machine, as is done on conventional processing of rectangular/triangular/symmetric matrix data on these machines.

It is another exemplary feature of the present invention to improve factorization routines, which are key procedures of linear algebra matrix processing.

It is another exemplary feature of the present invention to incorporate a number of improvements into the parallel processing environment a number of changes that have been discussed in other commonly-assigned applications to be specifically identified below, as updated to function in the environment of the atomic data blocks of the present invention. The hierarchical description of matrix layouts is extended “up” by the present invention from register layouts discussed in these earlier applications to parallel layouts of the present invention.

It is another feature of the present invention to provide the ability to use standard level 3 BLAS on the new data layouts presented herein, thereby allowing standard off-the-shelf software to be used in the parallel-processing environment.

It is another feature of the present invention to provide the ability to avoid using ScaLapack PBLAS (Parallel BLAS) modules because the atomic blocks of data of the present invention can be processed in each process by using conventional BLAS software modules.

To achieve at least the above features, in a first exemplary aspect of the present invention, described herein is a computerized method of linear algebra processing on a computer having a plurality of processors interconnected in a mesh for a parallel processing of data, including, for a matrix data to be used in processing a matrix operation on the mesh of processors, organizing the matrix data into atomic blocks of data for distribution onto the mesh of processors for processing, wherein at least one of the atomic blocks of data comprises an increment of the matrix data that is stored as an atomic block unit in a memory of at least one of the processors in the mesh as being managed for processing as a unit of data during the matrix operation processing.

In a second exemplary aspect of the present invention, described herein is an apparatus for linear algebra processing, including a plurality of processors for executing a parallel processing operation, at least one of the processors comprising a memory for storing data during the parallel processing operation and a main memory initially storing matrix data to be used in said linear algebra processing, wherein the matrix data stored in said memory is organized into atomic blocks of matrix data for a distribution of the matrix data to the plurality of processors, at least one of the atomic blocks to be managed for processing during said parallel processing operation as a unit of matrix data.

In a third exemplary aspect of the present invention, described herein is a signal-bearing medium tangibly embodying a program of machine-readable instructions executable by a digital processing apparatus to perform a computerized method of linear algebra processing on a computer having a plurality of processors interconnected in a mesh for a parallel processing of data, each of the processors comprising a memory for storing data during the parallel processing operation, including, for a matrix data to be used in processing a matrix operation on the mesh of processors, organizing the matrix data into atomic blocks of data for a distribution of the matrix data onto the mesh of processors, wherein at least one the atomic blocks comprises an increment of the matrix data that is managed during the matrix operation processing to be processed as a unit of data.

In a fourth exemplary aspect of the present invention, also described herein is apparatus for linear algebra processing, including a plurality of processors for executing a parallel processing operation, at least one of the processors comprising a memory for storing data during the parallel processing operation; a distributing module to distribute matrix data onto at least some of the plurality of processors; and a data reformatting module so that the distributing matrix data, for any of a matrix having elements originally stored in a memory in one of a triangular matrix format and a symmetric matrix format, allows substantially only essential data of the triangular or symmetric matrix to be transferred to the processors for the processing, the essential data being data of the triangular or symmetric matrix that is minimally necessary for an information content of the triangular or symmetric matrix.

The atomic blocks of contiguous matrix data of the present invention provide a number of benefits for processing data in a parallel-processor machine, including a decrease of the memory requirements in the processor grid for triangular/symmetric linear algebra routines, as well as increasing speed and performance of processing such routines.

The present invention achieves the three following benefits:

(1) For rectangular and triangular/symmetric matrices, it presents a simpler interface;

(2) For rectangular and triangular/symmetric matrices, it produces better performing algorithms; and

(3) For triangular/symmetric matrices it provides two minimal storage solutions that outperforms the current full storage solutions.

Other major features and advantages of the present invention will be identified once the method is explained and some terminology has been presented.

### BRIEF DESCRIPTION OF THE DRAWINGS

The foregoing and other exemplary features, aspects and advantages will be better understood from the following detailed description of exemplary embodiments of the invention with reference to the drawings, in which:

FIG. 1 illustrates the full (rectangular) matrix format compared to the triangular (packed) matrix format;

FIG. 2 illustrates how storing a triangular matrix in memory in full format provides a poor utilization of memory space and, when such memory space contents is mapped upon a grid of processors, would cause an analogous problem because the unnecessary “don't care” or redundant data is inherently mapped to the processors for execution of linear algebra subroutines;

FIG. 3 illustrates in flowchart format 300 showing the general concept of the present invention as improving storage/processing efficiency of triangular matrix data in a parallel processor machine by distributing substantially only the essential matrix data to the processor grid;

FIG. 4 simplistically illustrates the block packed format mapping technique 400 of the exemplary first embodiment;

FIG. 5 simplistically illustrates the technique 500 of the exemplary second embodiment using the hybrid full-packed format;

FIG. 6 shows an exemplary 18×18 block triangular array 600 to be used in explaining the exemplary embodiments of the present invention;

FIG. 7 shows the distribution 700 of the triangular array data 600 in a column wrap-around mapping onto a 5×3 mesh of processors;

FIG. 8 shows, for comparison, the distribution 800 of the matrix 700 the triangular array data 600 on a processor grid of size 4×4;

FIG. 9 illustrates pictorially, for explanation in the present invention, the hybrid full-packed (HFP) data structure 900 discussed in the first of the above-identified co-pending applications and the conversion process 901 from triangular matrix data 902 into the rectangular-shaped hybrid full-packed format 900 as taught therein;

FIG. 10 illustrates pictorially the process 1000 for obtaining a second hybrid full-packed data structure B of the invention discussed in the second of the above-identified co-pending applications and the conversion process from lower triangular matrix data A into the rectangular-shaped hybrid full-packed format B as taught therein;

FIG. 11 shows the corresponding process 1100 for an upper triangular matrix for the second hybrid full-packed format;

FIG. 12 provides an exemplary flowchart 1200 of the second embodiment of the present invention, using one of the hybrid full-packed data structures as the mechanism for eliminating superfluous matrix data;

FIG. 13 shows the mechanism 1300 of block cyclic distribution of the HFP data structure onto an exemplary processor grid;

FIG. 14 shows specifically how the T2 triangular data 600 shown in FIG. 6 is re-flected its main diagonal;

FIG. 15 shows the final rectangular hybrid full-packed data structure 15 resultant from the process initiated in FIG. 14;

FIG. 16 shows the results 1600 of the column wrap-around mapping of the hybrid full-packed data structure 1500 onto a 5×3 grid of processors;

FIG. 17 shows visually 1700 how Cholesky factorization proceeds across triangular data in columns of data blocks in a parallel-processor implementation for a triangular matrix that has not been converted into hybrid full-packed format;

FIG. 18 shows the symbology for discussing Cholesky factorization processing;

FIG. 19 shows the global-to-local mapping glp 1900 for the packed format of the first embodiment;

FIG. 20 shows the inverse mapping lgp 2000 for the packed format of the first embodiment;

FIGS. 21 and 22 show exemplary states 2100, 2200 of the processor grid processing to illustrate send/receive processing steps of the second embodiment;

FIG. 23 shows the global-to-local mapping gl 2300 for the second embodiment;

FIG. 24 shows the local-to-global mapping lg 2400 for the second embodiment;

FIG. 25 illustrates the update process 2500 when j=11 in the discussion of the second embodiment;

FIG. 26 illustrates an exemplary hardware/information handling system 2600 for incorporating the present invention therein; and

FIG. 27 illustrates a signal bearing medium 2700 (e.g., storage medium) for storing steps of a program of a method according to the present invention; and

FIG. 28 illustrates an exemplary block diagram 2800 of functional software modules used to implement the present invention as a software tool.

### DETAILED DESCRIPTION OF EXEMPLARY EMBODIMENTS OF THE INVENTION

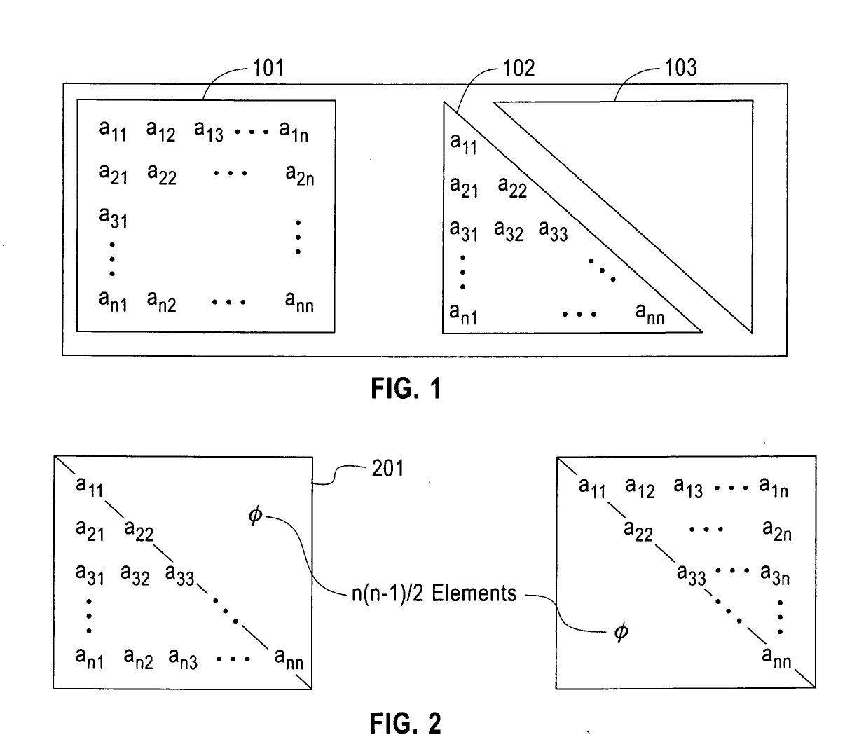

Referring now to the drawings, and more particularly to FIGS. 1-28, exemplary embodiments of the present invention will now be discussed. Generally, although the present invention provides a method to improve memory, efficiency, and speed in triangular/symmetric matrix linear algorithm processing in the parallel processing environment, its method benefits in a broader sense of improving processing in parallel-processor machines.

The present inventors have recognized that the existing triangular/symmetric matrix subroutines for parallel processors are inefficient, first, because of the extra storage inherently needed when triangular/symmetric matrix data is stored in conventional rectangular storage space (e.g., reference the above-identified two co-pending applications discussing the hybrid full-packed data structure) with superfluous data and, second, because of the inherent loss of processor efficiency when processors in the parallel processing grid have to repeatedly relocate, copy, and manage both the essential and non-essential data, which the new data formats presented herein do not have to do.

The present invention addresses both these problems by preventing superfluous (e.g., zero, “don't care”, or redundant) data in triangular/symmetric matrix data from being distributed to the processor grid and by differently storing the essential data so that the essential data is carried to the processors in atomic units of contiguous data that will later be demonstrated as permitting more efficient processing.

However, as will be discussed in more detail later, a more fundamental aspect of the present invention is that the matrix data is preliminarily organized into atomic blocks of data, which atomic blocks of data will be distributed to the processor grid in techniques to be described. This concept of using atomic blocks of data is a significant feature of the present invention that provides benefits beyond its use in the processing of triangular/symmetric matrix data, as will be explained later.

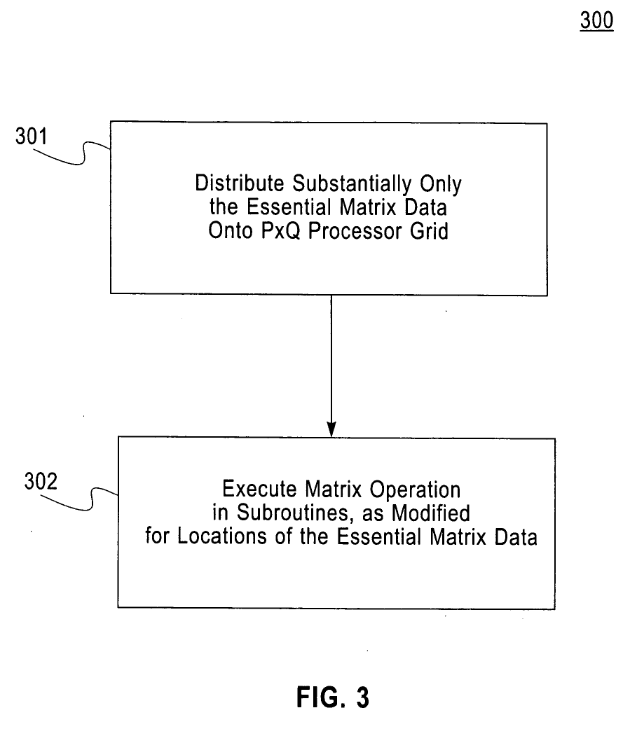

FIG. 3 shows an exemplary flowchart 300 of the generic concepts of the present invention as related to triangular/symmetric matrix processing, wherein, in step 301, substantially only the essential data of matrix data is distributed to the parallel processor mesh and, in step 302, the matrix operation is then executed as processes on the processors. It is noted at this point that the term “mesh” is used interchangeably with “grid” as describing the parallel-interconnection of processors, but it should also be pointed out that the “grid” may wrap around itself at certain multiples (e.g., 8), thereby forming multiple toroidal interconnections rather than a strict two dimensional grid.

Two exemplary methods are described that overcome this inherent burden of superfluous data for triangular/symmetric matrix data, but the concept is more correctly viewed as being the more generic concept of presenting to the processors only the essential data, preferably in blocks of data that are atomic units of contiguous data and that are distributed in a manner conducive to efficiency of the execution of the algorithm by the processors.

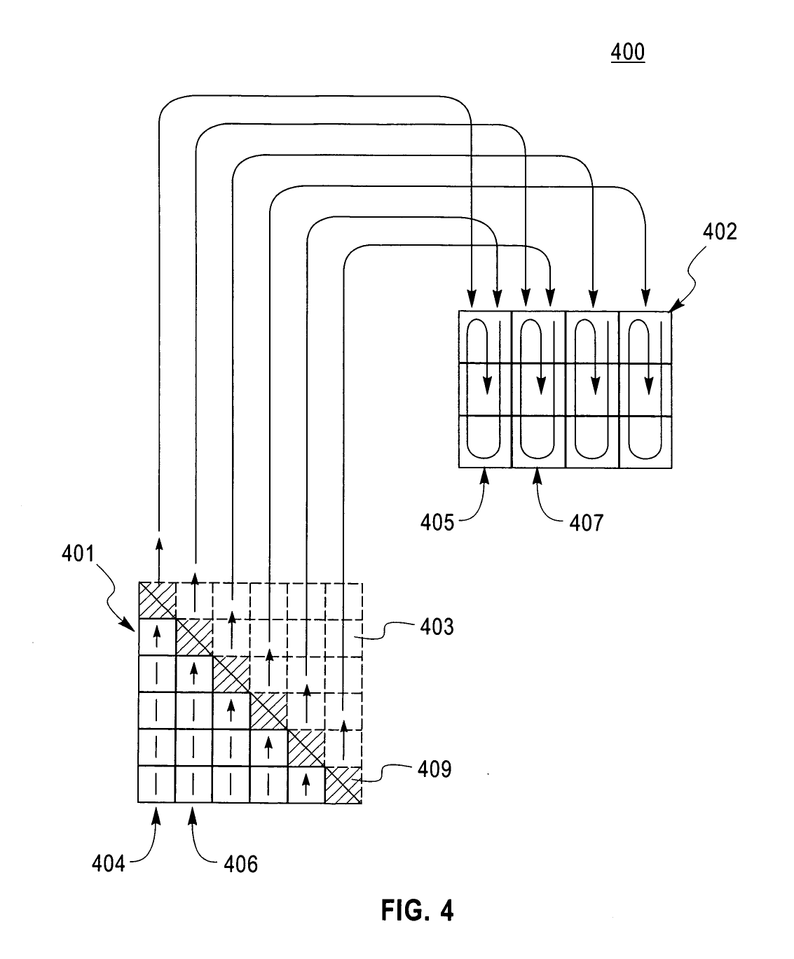

As a preliminary overview, in a first exemplary embodiment demonstrated simplistically in FIG. 4, the triangular matrix data 401 is mapped directly from memory onto the 3×4 processor grid 402 in a specific systematic manner that selectively transfers substantially only the essential data, thereby eliminating the superfluous data 403 from being distributed to the grid 402, by essentially simply selectively ignoring it during the distribution process. But the concept is more than merely ignoring the non-essential data, since another key feature of the present invention is the distribution of atomic units of contiguous essential data blocks into the processor grid in a manner predetermined as conducive to the processing of the algorithm.

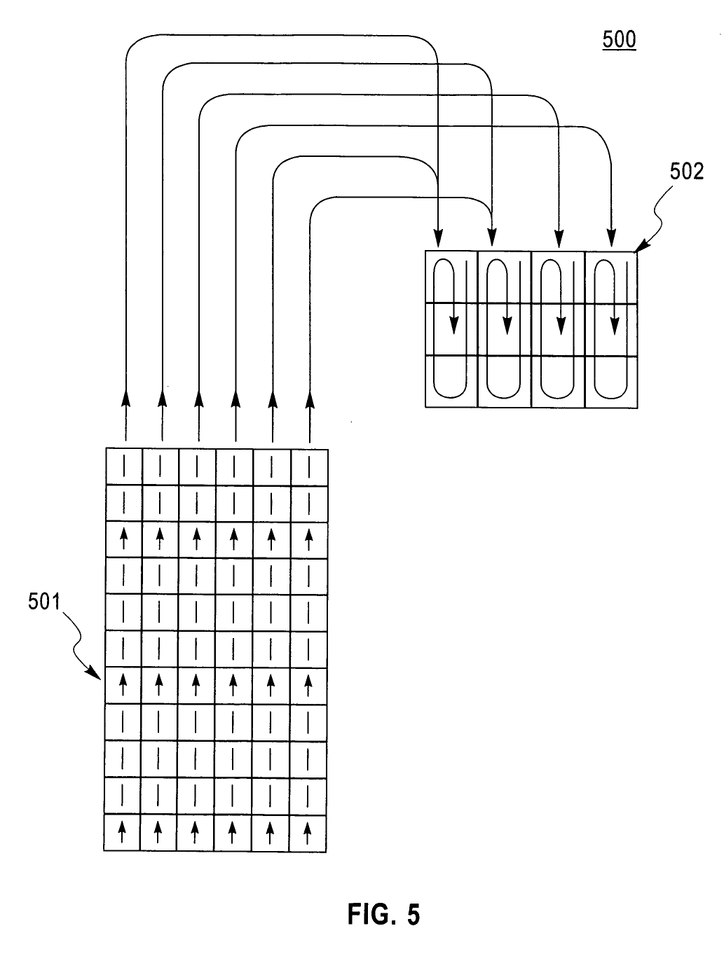

In a second exemplary embodiment demonstrated by FIG. 5, the triangular matrix data is first converted into a rectangular data structure 501, using either of the two hybrid full-packed formats separately described in the above-identified co-pending applications and briefly described below. In this second embodiment, therefore, the superfluous data is prevented from being distributed by reason that the triangular/symmetric data is first converted into a rectangular-shaped data structure substantially devoid of the superfluous data.

This rectangular data structure is then distributed to the processor grid 502 in a block cyclic distribution described shortly, again, typically in increments of smaller square or rectangular blocks of contiguous matrix data. The processor grid 502 then executes the matrix operation, using conventional matrix subroutines, as modified to adapt to the relocation of the data in the hybrid full-packed format, to be further explained later.

For purpose of demonstration, the hybrid full-packed format of the second co-pending application, in which the essential data of a triangular matrix has been converted into a single data structure having data (block) elements accessible as a single entity in memory, is used. However, the hybrid full-packed format of the first co-pending application can be similarly applied with relatively minor changes in details.

The first embodiment has an advantage over the second embodiment in that it can provide a layout of the matrix data on the processor grid for which the matrix subroutine processing becomes more straightforward. That is, as discussed later, if the data blocks are distributed to the processor grid in a manner that simulates how conventional methods distribute the matrix data as carrying along the superfluous data, then the essential data blocks are placed in the same position as conventional matrix routines have been programmed to process the data.

In contrast, the second exemplary embodiment relocates a portion of the original matrix data during the formation of the rectangular data structure, and this data relocation requires adaptations of the subroutine processing, as will be discussed in more detail below.

Eliminating the burden inherent with superfluous triangular-matrix data in conventional triangular/symmetric matrix subroutine processing in parallel processor grids frees each processor in the grid from having to reserve almost 100% additional storage, relative to the amount of essential data. Although the good data and the irrelevant data are entangled in a predictable pattern in conventional methods, during processing, parts of the overall data, in particular, the good data, have to be extracted, placed into send buffers, and sent to other processors (e.g., receive buffers). On the receiving processor unit, the data is then tangled-up again in the movement from receive buffers into the storage used by the receiving processor unit.

As will be seen, the present invention also eliminates much of this inherent data entanglement.

Along this line, it is noted at this point that the mapping shown in both FIG. 4 and FIG. 5 between the matrix data 401, 501 and the processor grid 402, 502 is a wrap-around mapping based on columns of matrix data. This column-based mapping is consistent with conventional mapping of such matrix data onto the processor grid.

As previously mentioned, a number of methods have been used to improve performance of computer architectures for linear algebra processing. However, the input data structures of matrices have not changed for conventional programming languages and standardized libraries. More particularly, there are two data structures used for symmetric and/or triangular matrices, referred to as “packed” and “full”.

The “packed” format uses half the storage, but performs, on average, three to five times slower. “Full” format uses twice the storage of packed, but performs three to five times faster than packed and has been observed to perform as high as 20 times faster, especially for large problems where performance is particularly important.

FIG. 1 shows the standard full format 101 familiar to most computer programmers, since Fortran and C operate on arrays as rectangular entities. In contrast, triangular and symmetric arrays 102, 103 store matrix data in a format resembling a triangle, either a lower triangular packed matrix 102 or an upper triangular packed matrix 103.

As shown in FIG. 2, if triangular array 102 is stored in standard full format 201, almost half of the memory positions are “wasted” (e.g., unused). Since full formats 201 are the only formats supported by Fortran and C, they have traditionally been used by most users of dense linear algebra software. The wasted memory space when triangular matrices are stored in memory is a problem addressed by the hybrid full-packed format, but other aspects include speed and, when executed on a parallel processing environment, the problem of “don't care” data causes parallel processors to lose some efficiency.

Triangular and symmetric matrices T, S are special cases of a full square matrix A (e.g., having order N, where A has n rows and n columns). Triangular and symmetric matrices can be represented in full format. Assuming an example where N=4, the 4×4 matrix A will have 16 elements.

$$T = \begin{matrix}{t}_{11} & 0 & 0 & 0 \\ {t}_{21} & {t}_{22} & 0 & 0 \\ {t}_{31} & {t}_{32} & {t}_{33} & 0 \\ {t}_{41} & {t}_{42} & {t}_{43} & {t}_{44}\end{matrix}$$

$$S = \begin{matrix}{s}_{11} & {s}_{21} & {s}_{31} & {s}_{41} \\ {s}_{21} & {s}_{22} & {s}_{32} & {s}_{42} \\ {s}_{31} & {s}_{32} & {s}_{33} & {s}_{43} \\ {s}_{41} & {s}_{42} & {s}_{43} & {s}_{44}\end{matrix}$$

Because S above is symmetric, it has six redundant elements (e.g., s₂₁, s₃₁, s₄₁, s₃₂, s₄₂, s₄₃), and because T has zeroes above the diagonal, it also has six elements of no interest. It is this zero, redundant, or “don't care” data that is described by the term “superfluous data” in this discussion. Still, storage must be allocated for these six elements in S. In general, the example above, having N=4, shows that N(N−1)/2=6 elements of triangular and symmetric matrices contain not needed (e.g., 0's or redundant) information.

The following exemplary description of the present invention refers to a current linear algebra computing standard called LAPACK (Linear Algebra PACKage) and various subroutines contained therein. ScaLAPACK is LAPACK as adapted for use on parallel-processor computer architectures. Both ScaLAPACK and LAPACK are based on Basic Linear Algebra Subprograms (BLAS), and information on LAPACK, ScaLAPACK, and BLAS is readily available on the Internet.

When LAPACK is executed, the Basic Linear Algebra Subprograms (BLAS), unique for each computer architecture and typically provided by the computer vendor, are invoked. LAPACK includes a number of factorization algorithms, some of which will be mentioned shortly.

However, it is also noted that the present invention is more generic. That is, the concept presented in the present invention is not limited to conventional LAPACK, ScaLAPACK, or BLAS, as one of skill in the art would readily recognize after having taken the present application as a whole. The present invention is intended to cover the broader concepts discussed herein and the specific environment involving LAPACK and ScaLAPACK is intended for purpose of illustration rather than limitation.

As an example, the floating point operations done on Dense Linear Algebra Factorization Algorithms (DLAFAs) consist almost entirely of matrix multiply subroutine calls such as Double-precision Generalized Matrix Multiply (DGEMM). At the core of level 3 Basic Linear Algebra Subprograms (BLAS) are “L1 kernel” routines which are constructed to operate at near the peak rate of the machine when all data operands are streamed through or reside in an L1 cache.

The current state-of-the-art for DLAFAs is based on using level 3 BLAS on the two matrix data formats, “full format” and “packed format”. Because these data formats are not the data formats used by the level 3 BLAS routines, excessive data copying is necessary, resulting in a performance loss.

The terminology “level x BLAS”, where x=1, 2, or 3, refers to the number of “do” or “for” loops involved. Thus, level 1 BLAS involves a single “do” loop and level 1 BLAS subroutines typically have an order of n operations, where n is the size of the “do” loop. Level 2 BLAS involve two “do” loops and typically have an order n operations, and level 3 BLAS involve three “do” loops and have an order n³ operations.

The most heavily used type of level 3 L1 DGEMM kernel is Double-precision A Transpose multiplied by B (DATB), that is, C=C−AˆT*B, where A, B, and C are generic matrices or submatrices, and the symbology AˆT means the transpose of matrix A. The example of matrix processing used for discussion later is the Cholesky factoring algorithm.

As shown in FIG. 1, the triangular (packed) format 102, 103 shown in FIG. 1 has a stride LD that varies in the vertical dimension. “Stride” is the unit of data separating two consecutive matrix elements (e.g., in row or column, depending upon the storage indexing format) retrieved from memory.

Because of this varying stride, matrix subroutines in LAPACK for the packed format exist only in level 2 BLAS, which is significantly slower than level 3 BLAS matrix subroutines for the full format. As seen in FIG. 1, a full format matrix 101 has a constant stride LD between elements in a row, whereas the triangular format varies.

Along these lines, a major advantage of the present invention is that the new data layouts as contiguous atomic units (blocks or submatrices) allows for the possibility of using existing standardized software. That is, existing level 3 BLAS software modules can be used to perform the required processing on these submatrices. This advantage is important, since it means that the newer BLAS software modules developed for the parallel processing environment, referred to as PBLAS (Parallel BLAS), can be eliminated by the present invention.

It is also noted at this point that the present invention covers rectangular (AR) layouts as well as symmetric (AS)/triangular (AT) layouts. Although AR, AS, and AT layouts are all covered, the following discussion focuses more on the AS symmetric layouts, since this layout (along with the AT layout) has the additional feature of producing a near-minimal storage layout.

### First Exemplary Embodiment

### Directly Mapping Triangular Matrix Only the Essential Data to the Processor Grid (the Block Packed Format)

In the first exemplary embodiment, superfluous triangular data is essentially eliminated by selectively mapping the substantially only the essential data, typically, in units of blocks of data (often referred to herein as “atomic blocks of contiguous data” because a preferred embodiment specifically incorporates contiguous data to be described later), onto the processor grid, using a column-by-column wrap-around mapping.

FIG. 4 exemplarily shows this wrap-around mapping 400 onto a 3×4 processor 402 for a lower triangular matrix 401 stored in memory with superfluous data 403. The mapping 400 begins at the data blocks of the left column 404 of essential data 401 by sequentially mapping the data blocks onto the first column 405 of the processor grid 402 in a wrap-around manner.

Remaining columns of matrix essential data blocks are also respectively mapped in a wrap-around manner to a column in the processor grid 402, as shown by the second column 406 of essential data being mapped to the second column 407 of the processor grid. Since there will typically be many more columns of data blocks in the matrix 401 than columns in the processor grid 402, the column correspondence will also display a wrap-around nature, as shown in FIG. 4 by mapping the fifth matrix column 408 back onto the first processor grid column 405.

This specific mapping technique, referred to herein as “block packed cyclic data distribution”, preserves the placement of these matrix data blocks 401 in the locations best suited for executing the algorithm, thereby achieving a second aspect of the present invention in which matrix data is mapped in units of “atomic blocks” of (preferably, contiguous) matrix data such that location is predetermined to accommodate the routines performing the matrix operation.

It is noted at this point that the atomic blocks of contiguous matrix data of the present invention differs in various fundamental concepts from the previous use of square blocks of matrix data mapped onto a parallel processor mesh.

First, in the present invention, the atomic blocks are maintained as discrete blocks of data throughout the processing on the processor mesh. That is, they are processed and moved in units corresponding to the original atomic blocks of data throughout the processing of the operation on the processor mesh. Because the atomic blocks comprise contiguous data that is substantially only essential data, they can be manipulated during processing as a unit of contiguous data. For example, the block can be readily converted into transpose data as a square block of data.

Earlier methods of using matrix data blocks on parallel processors did not attempt to consider the blocks as units of contiguous data that could maintain operations on each data block in a unit of an atomic block of data, as opposed to treating the blocks as being data units that are processed as elemental data units.

Relative to the preferred embodiment in which data in the atomic blocks is contiguous data, data in memory is mapped to cache in units called lines. Almost all cache mappings take the lower bits of a memory location to determine where in cache that memory location will reside. It follows that a contiguous block of memory, bl(α: α+N−1), of size N, where α is the memory address of the first word and α+N−1 is the memory address of the last word, will map into cache in the best possible way. Here, N is less than or equal to the size of cache. When the term “contiguous” is used herein, such as a “contiguous block of size N”, this terminology means that the block's N words are in memory locations α through α+N−1, beginning at memory location α.

A second characteristic is that the atomic block concept allows the original matrix data to be scattered onto the processor grid for any value of P′ and Q′ of processors that a user desires to utilize out of a specific parallel machine's P×Q processor mesh or for any constraints that a specific machine might impose. Thus, the atomic blocks allow the present invention to be implemented for any arbitrary P and Q of a P×Q processor mesh.

Third, because the atomic data blocks of the present invention contain substantially only essential data, the processing of these atomic data blocks do not involve the entanglement of essential/non-essential data that the present inventors have recognized as being a source of processing inefficiency because the data had to be repeatedly untangled and copied throughout the processing on the processor mesh. The atomic blocks of the present invention are moved as a unit and the untangling of data is largely eliminated because very little of the matrix data on the processor mesh is superfluous data.

Fourth, the atomic blocks have another distinguishing feature, to be discussed in more detail in the later discussion of the Cholesky factorization processing, that each processor on the processor mesh is considered as surrounded by a border of send/receive buffers that respectively can store an atomic block as a unit. This concept permits the data to be easily sent and received by processes on the processor mesh in units these atomic block units. This feature eliminates most of the processing inefficiency of previous methods in which data is required to be repeatedly copied and disentangled during the broadcasting and other processing steps of teh Cholesky factorization processing.

It is also again noted that the diagonal blocks of data 409, shown in FIG. 4 as filled in with diagonal lines, will actually contain data elements from both the essential data 401 and the non-essential data 403, in order to generate the data blocks. It should be apparent that, as the atomic block size approaches the size of a single data element (e.g., a 1×1 block size), the amount of superfluous data carried along in these diagonal data blocks approaches zero.

It should also be noted that this small amount of superfluous data is minimal compared to the total amount of superfluous data 403 and is much more easily accommodated during processing than the situation in which the entire superfluous data 403 is distributed to the processor grid. Because there is a small amount of superfluous data 403 distributed in the present invention, it is more proper to describe this mapping technique onto the processor grid 402 as distributing “substantially” only the essential data 401 to the processor grid 402.

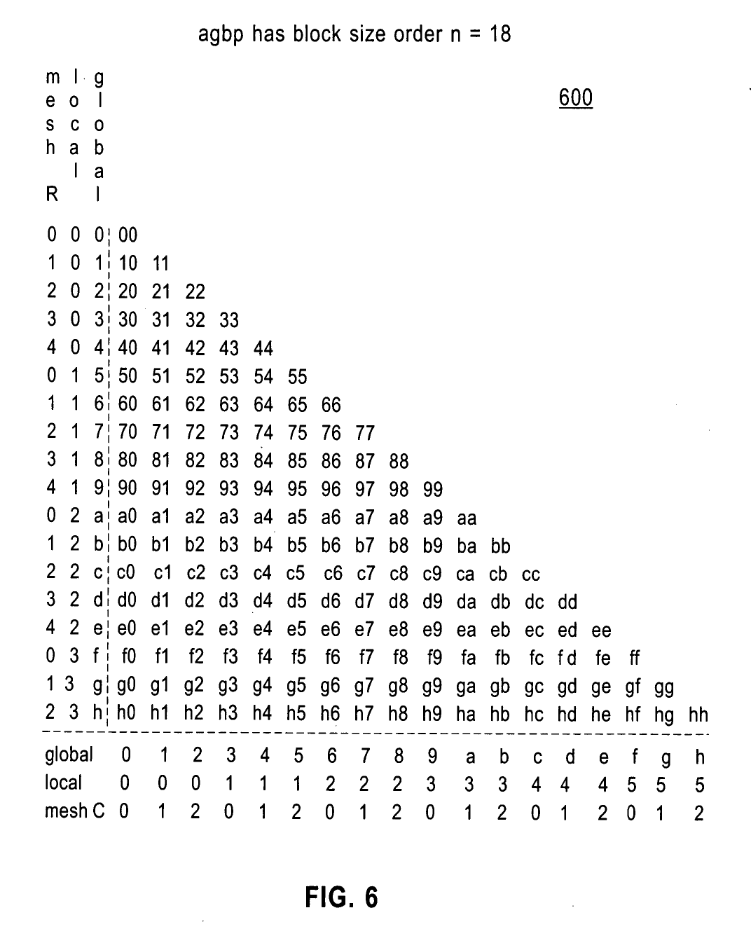

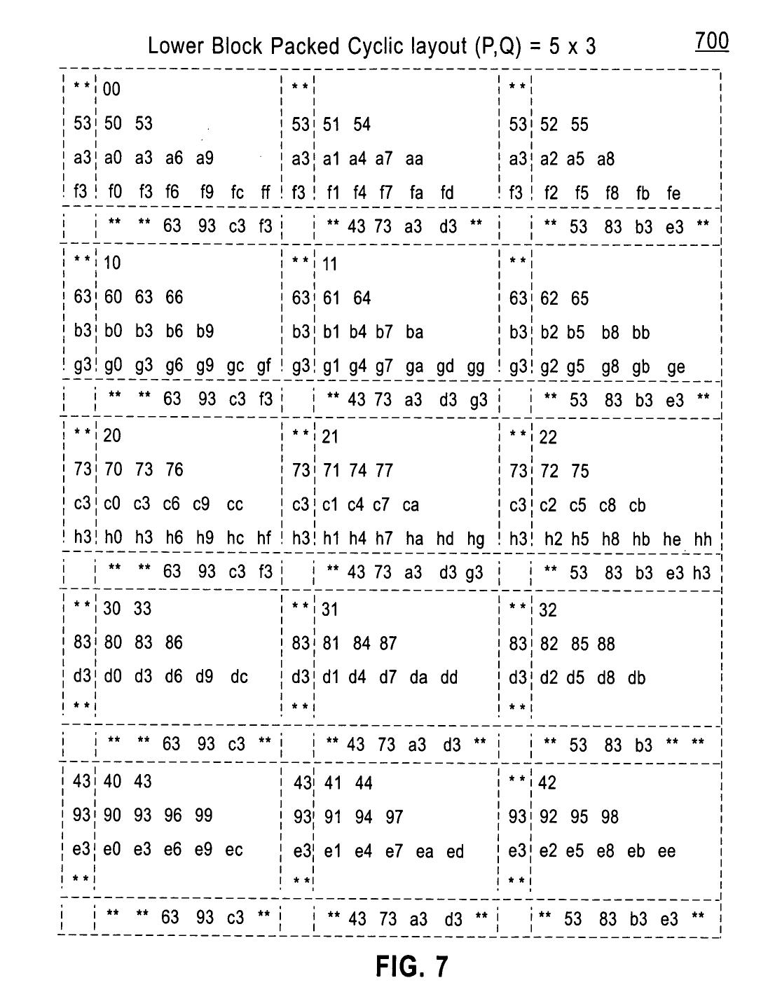

FIG. 6 shows an exemplary lower triangular matrix having n=18 blocks, and FIG. 7 shows the resultant distribution 700 of these data blocks on a processor grid of size 5×3. It is noted that the lower triangular matrix shown in FIG. 6 will also be used for discussing the second embodiment.

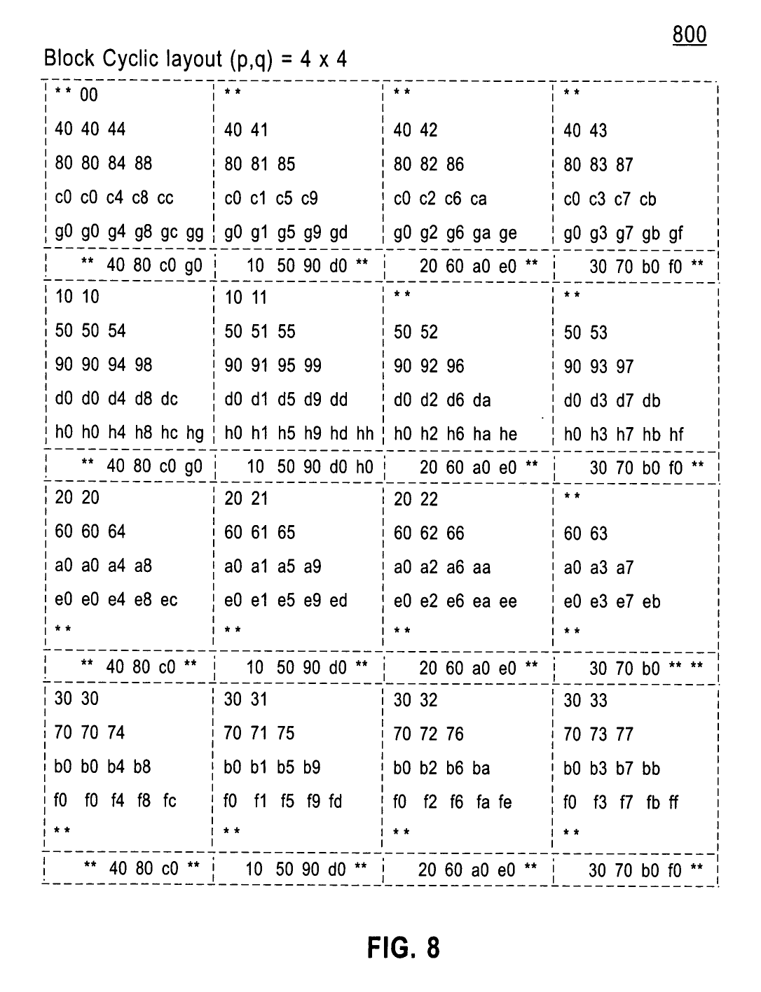

For comparison of how processor grid size affects the resultant distribution, FIG. 8 shows the resultant distribution 800 on a processor grid having size 4×4. However, it is also noted that the same algorithm executes on either processor grid, so that the present invention is not affected by specific processor grid sizes or by changing the processor grid size. In FIG. 7, the West and South Schur complement buffers are filled with the scaled pivot blocks (SPB) of pivot step jp=3. In FIG. 8 these same buffers are filled with the SPB of pivot step jp=0.

In fact, here a power of the present invention can be seen in that, for all P and Q, the data blocks themselves are “atomic” and, hence, can always be moved as contiguous blocks. This is not so for the standard data layouts.

It should also be noted that the block packed cyclic distribution of the first embodiment results in a “triangular-like” data allocation on each processor, which is readily apparent in FIGS. 7 and 8. This is a result of the definition of the new mapping in which only the lower triangular data blocks are distributed to the processors of the grids.

Therefore, as previously mentioned, it should now be apparent that the first embodiment has the advantage that conventional algorithms for the processing of the operation would have minimal changes from the re-arrangement of the data blocks, in contrast to effect of distribution of data blocks as achieved in the hybrid full-packed data structure of the second embodiment.

It should also be apparent at this point that variations are clearly intended as covered by the broader concepts earlier mentioned.

Thus, for example, it should be readily recognized that, although only lower triangular matrices have been used in the discussion, the concepts of these two exemplary embodiments are easily adapted to upper triangular and symmetric matrices. Also, since matrix data is readily converted into transpose format, there are numerous variations due to matrix transposition.

It is noted that, rather than the column-based block cyclic distribution of the data (blocks) onto the processor grid, a row-based block cyclic distribution could be easily implemented, as might be useful when implementing the mapping for other matrix data situations, such as upper triangular matrix data or operations involving transposed matrix data.

Moreover, although the exemplary embodiments discussed herein used specific mapping patterns that have been developed to maximize efficiency in the transfer of data between processors during processing of the matrix operation, such specific patterns are not intended as limiting to the more fundamental and generic concept of the present invention of reducing the amount of superfluous data presented to the processor grid during distribution of matrix data. The same can be asserted concerning the efficiency that accrues in using square blocks instead of using standard data structures.

That is, the more fundamental concept of the reduction of superfluous data is effective, even if no additional precautions are taken to distribute the data in a manner that also provides efficiency of data transfer during processing, since storage requirements of the distributed data and computing resources for managing/copying of data that includes superfluous data are somewhat reduced by simply reducing/eliminating the amount of superfluous data.

Also, as previously mentioned, total elimination of superfluous data is not possible when blocks of data are distributed. That is, as shown in FIG. 4, generation of the data blocks along the triangle matrix diagonal elements requires that zeroes or don't-care data be left in place, in order to complete these diagonal blocks as being square/rectangular shaped data blocks. It is not desirable to attempt to entirely eliminate this superfluous data, since, as a practical matter, these filled in blocks represent a negligible increase in storage and, the condition of minimal storage would reduce performance by a large factor (e.g., an order of magnitude).

### The Second Exemplary Embodiment

### The Hybrid Full-Packed Data Structure as Adapted to the Parallel Processor Environment to Eliminate Superfluous Data

The second embodiment, briefly mentioned above in a cursory description of FIG. 5, differs from the block packed cyclic distribution of the first embodiment in that the relevant data is first converted into the hybrid full-packed data structure described in either of the two above-identified co-pending applications. In developing the hybrid full-packed data structure concepts, the present inventors also recognized that the conventional subroutines for solving triangular/symmetric matrix subroutines on parallel machines have been constructed in modules that handle triangular data as broken down into triangular and rectangular portions.

Therefore, recognizing that the hybrid full-packed data structure inherently provides such triangular and rectangular portions of matrix data and that the hybrid full-packed data structure also inherently includes only the essential data, as a second exemplary embodiment to substantially eliminate superfluous data, the present invention adapts this hybrid full-packed data structure specifically for the parallel processing environment.

The Hybrid Full-Packed (HFP) Data Structures

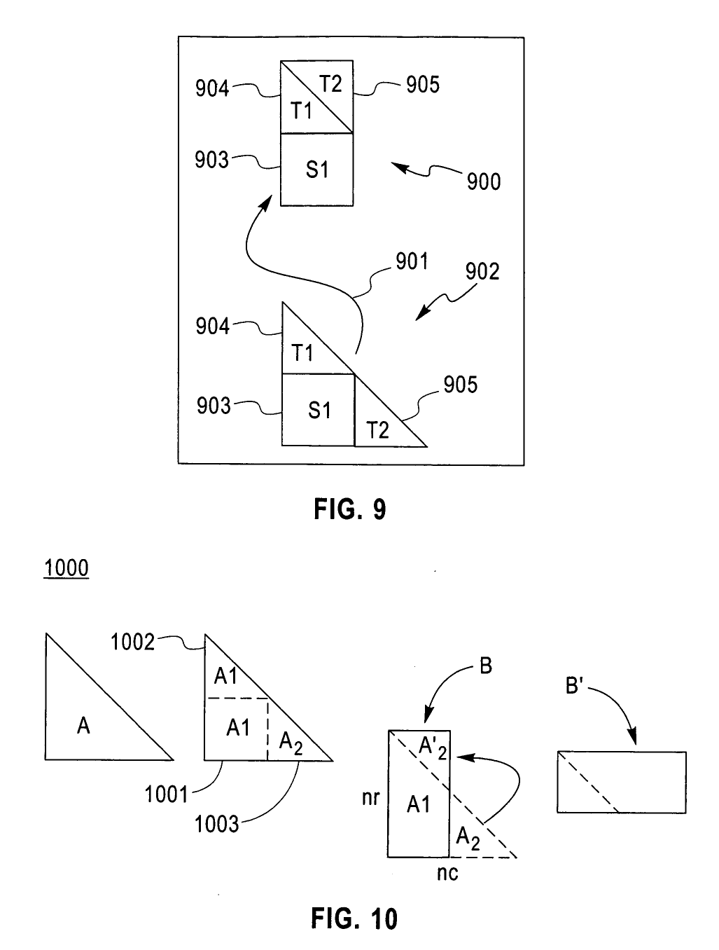

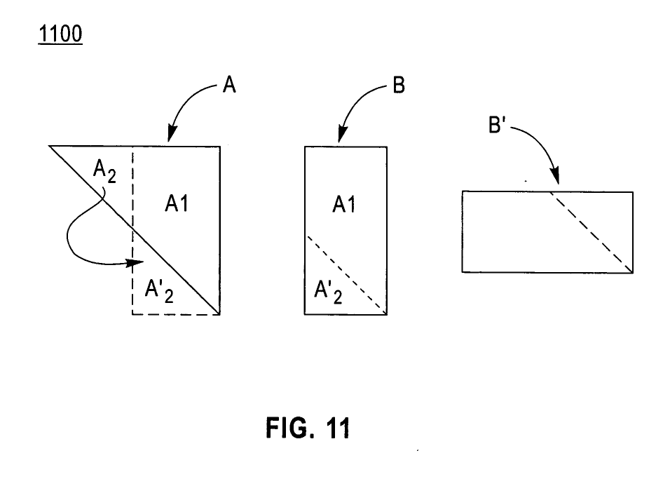

FIG. 9 exemplarily shows the matrix data format 800, the hybrid full-packed format, of the first above-identified co-pending application for a lower triangular matrix. FIGS. 10 and 11 exemplarily show the hybrid full-packed format of the second above-identified co-pending application for lower and upper formats, respectively.

Looking first at FIG. 9, the hybrid full-packed format 900 can be described as a reconstruction 901 of the square S1 data portion 903 and the triangular data portions T1/T2 904, 905 of triangular matrix 902 into the rectangular data structure 900. FIGS. 10 and 11 show a similar reconstruction in which only one triangular portion 1003 of data A₂ is separated and relocated relative to the original triangular/symmetric data A 1001, 1002 to form a rectangular block B of data (or, equivalently, the rectangular block B′, which is the transpose of B). One advantage of the embodiments of the hybrid full-packed format shown in FIGS. 10 and 11 is that a single rectangular block in memory is addressable using the (i,j) index format of conventional computer languages.

It is noted that any of the embodiments of hybrid full-packed formats of FIGS. 9, 10, and 11 has eliminated the “don't care” data elements shown in FIG. 2 that the present inventors have recognized as a source of inefficiency in parallel processing of triangular data.

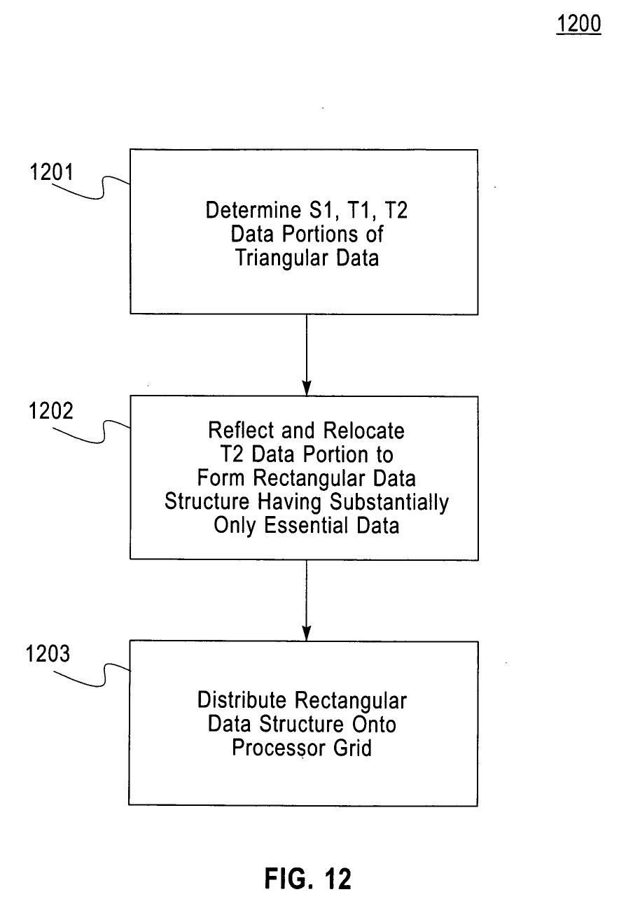

FIG. 12 shows an exemplary flowchart 1200 of the second embodiment wherein, initially, in step 1201, one of the versions of the hybrid full-packed format for triangular matrix data is formed by breaking the triangular matrix data down into portions S1, T1, and T2. In step 1202, portion T2 is transposed and relocated, as demonstrated in FIGS. 9-11. In step 1203, the rectangular-shaped hybrid full-packed data structure is then distributed in block cyclic format to of the processor grid, again, typically in atomic blocks of data as discussed for the first embodiment.

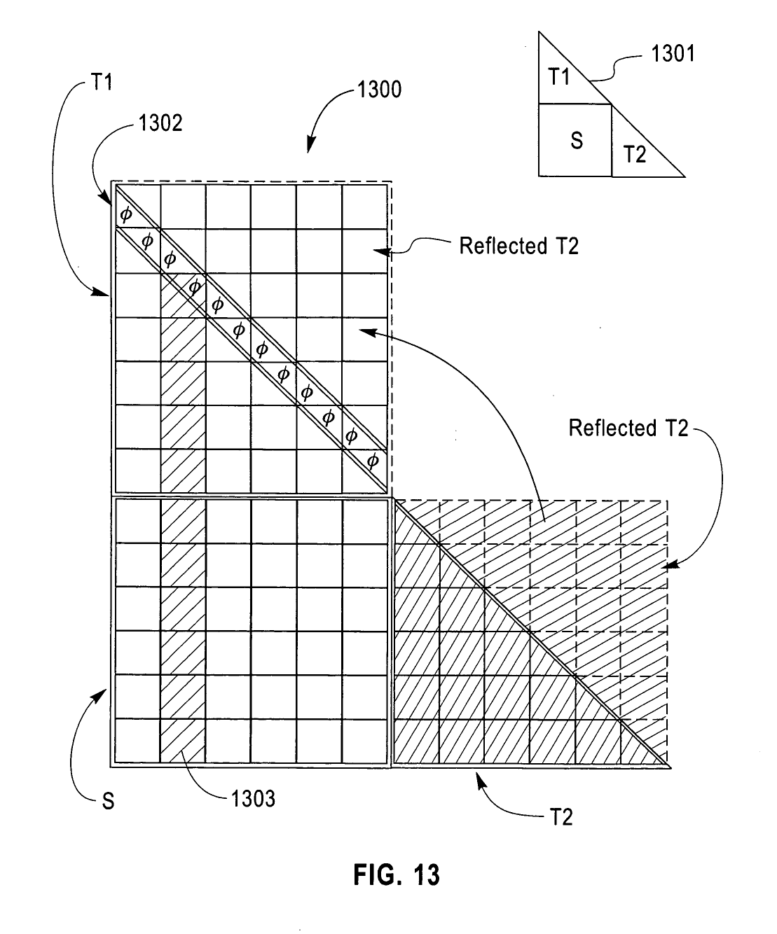

FIG. 13 shows simplistically how lower triangular matrix 1301 (upper right hand corner), initially having substantially square portion S, and two triangular portions T1 and T2, is converted into the hybrid full-packed format rectangular-shaped data structure 1300. Once the substantially square portion S is determined, trailing lower triangular portion T2 is reflected in its diagonal to form upper triangular T2 and then relocated to fit above triangular portion T1 to complete the rectangular-shaped data structure 1300. The blocks indicate the atomic data blocks, and there is a small amount of non-essential data along the diagonal 1302 in the data structure.

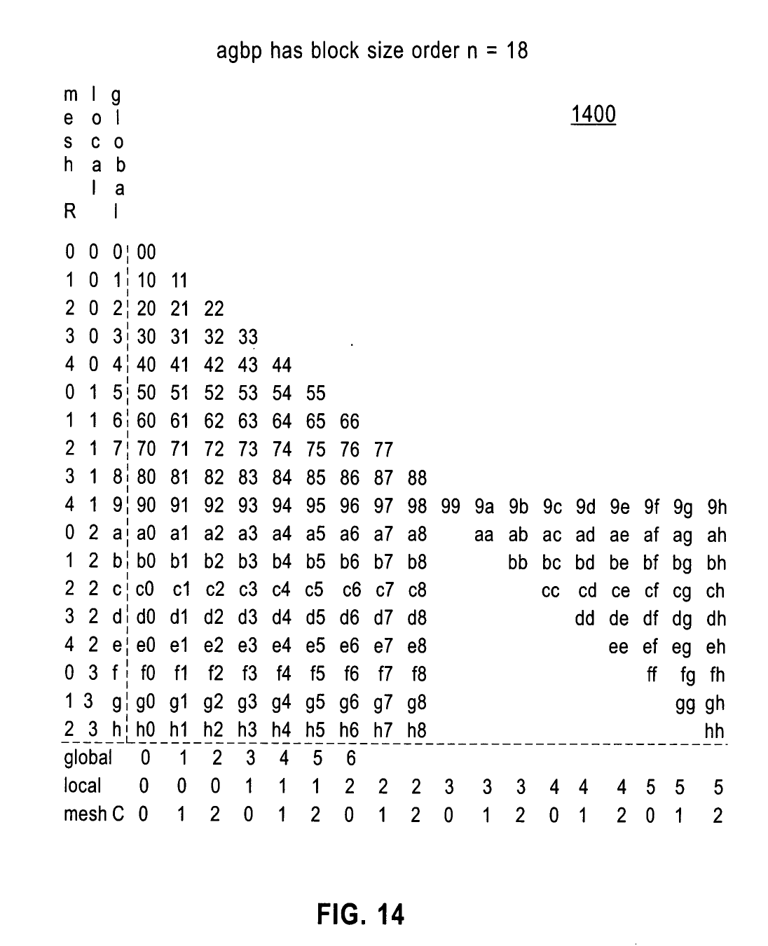

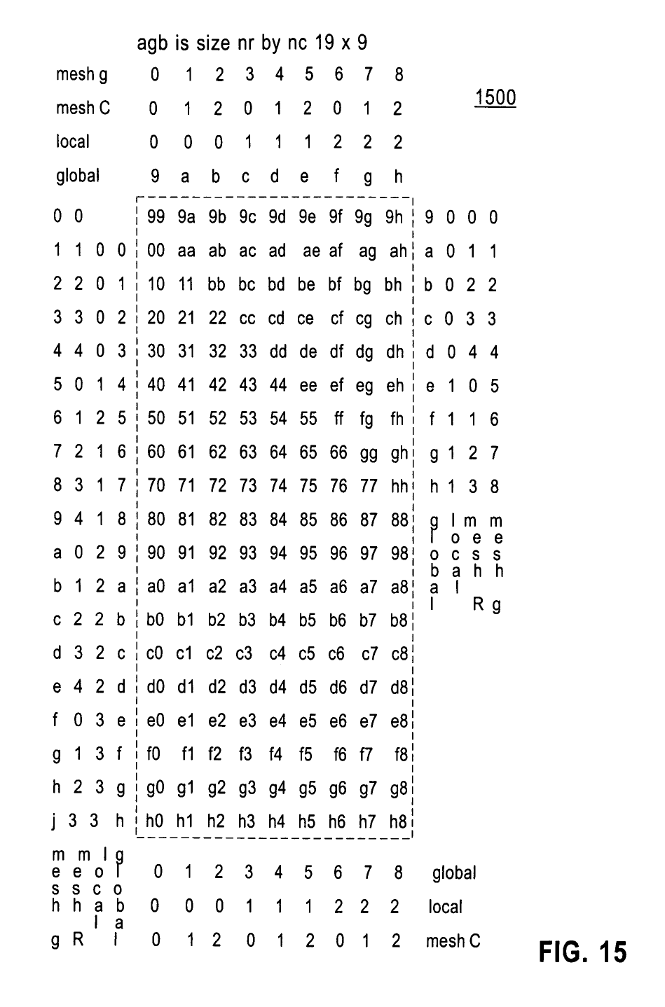

This rectangular-shaped data structure 1300 is then mapped onto the processor mesh, as earlier shown in FIG. 5, using the column-oriented wrap-around process. If the triangular matrix data earlier shown in FIG. 8 is considered as the original matrix data, then FIG. 14 shows the resultant conversion process discussed with FIG. 13, and FIG. 15 shows the completed hybrid full-packed data structure 1500.

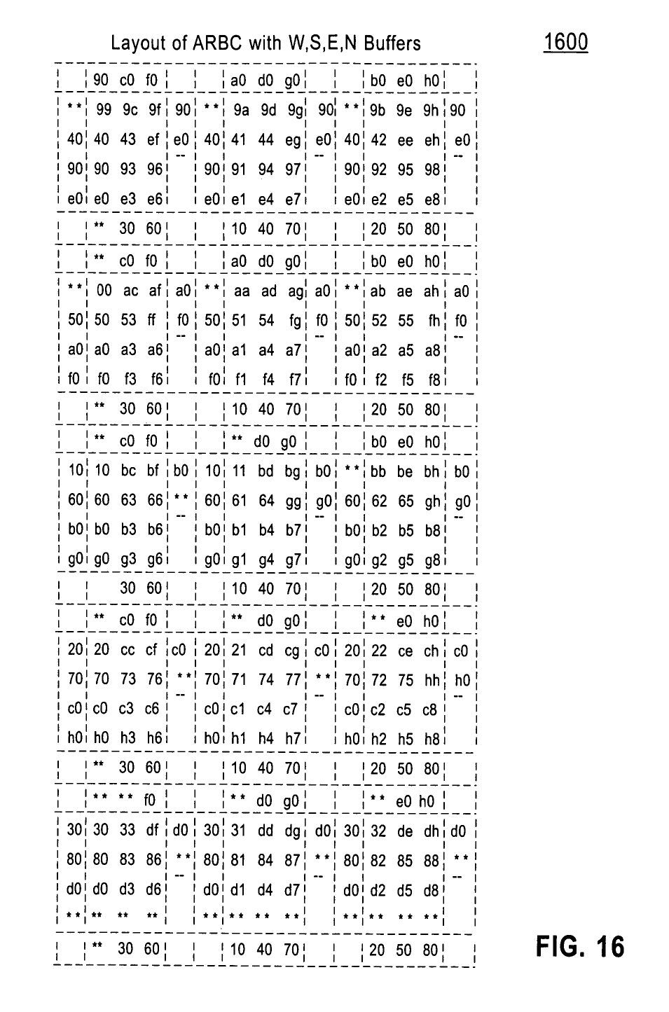

FIG. 16 shows how this hybrid full-packed data structure 1500 of FIG. 15 would be distributed in a block cyclic distribution onto a 5×3 processor grid. This distribution of the second embodiment can be compared to the distribution on the 5×3 processor grid for the first embodiment, as shown in FIG. 7.

In noticing, see FIGS. 14, 15, and 16, that the triangular portion T2 is displaced from its original position, it should be apparent that this relocation of a portion of data will require some adjustment to the processing of the matrix data that is based on a conventional matrix operation involving the original matrix data in its original relative location. The discussion of the adaptations needed for the distribution patterns of the present invention will be presented in the next section, using the Cholesky factorization as an exemplary linear algebra operation.

It should be noted that, as an alternative to completing the rectangular-shaped HFP data structure and then distributing it to the processor grid, the T2 transposition/relocation steps could be merged into the block cyclic distribution onto the processor grid, somewhat related in concept to the straightforward mapping concept of the first embodiment.

It is again noted that the distribution of matrix data onto the processor grid and the processing of the matrix data is typically done in incremental data blocks, typically square in shape. Therefore, similar in concept to the first embodiment, as demonstrated by the 0's along the diagonal 1302 in FIG. 13, there will be superfluous matrix in the second embodiment hybrid full-packed data blocks for those blocks of data on the triangle diagonal. One advantage for retaining this small amount of superfluous data is that existing code can be used that gives high performance. The extra storage necessary to fill in the blocks is minimal.

Some Advantages of the Present Invention

In summary, the two embodiments of the present invention demonstrate a number of advantages for improving speed, efficiency, and storage requirements of processing of matrix subroutines in the parallel processing environment that is actually greater than merely the substantial elimination of non-essential data for triangular and symmetric matrix data. Some of the characteristics provide benefits even for rectangular matrix data processing and processing in general in the parallel processing environment. Some of these advantages and benefits include extending the benefits described in earlier-filed, commonly-assigned applications into the parallel processing environment.

Benefits of the present invention include:

(1) Eliminating the superfluous (e.g., “don't care”) data that conventional processing methods carry along as excess baggage so that minimal storage can be used in the processor grids, particularly for the AT and AS layouts, where the excess baggage is approximately equal to the minimal storage.

(2) Storing the resulting reduced data in contiguous blocks of the size and in the locations required by the algorithm for the sending and receiving of data, which are needed for updating during processing. This capability is the idea of using atomic units comprised of blocks of contiguous matrix data for processing in each process. Typically, these blocks are square in shape. A significant feature of the present invention is that these atomic blocks are considered as increments of data processed as a unit, in any number of appropriate ways of processing.

(3) The ability to reformat each contiguous block into the format used by GEMM kernels. This reduces the data copy cost (over the whole algorithm) from O(N**3) to O(N**2). It is noted that this feature of the present invention is related to the discussion of an earlier, commonly-assigned application having identification Attorney Docket YOR920040315US1, U.S. patent Ser. No. 11/035,902 (“METHOD AND STRUCTURE FOR A GENERALIZED CACHE-REGISTER FILE INTERFACE WITH DATA RESTRUCTURING METHODS FOR MULTIPLE CACHE LEVELS AND HARDWARE PRE-FETCHING”), as extended to the parallel-processing environment.

(4) The present invention allows, as an option, the ability to use standard level 3 BLAS on these new data layouts. This feature means that standard off-the-shelf software can be used in the parallel-processing environment. This capability of the present invention results from the concept of atomic blocks of data, which, when laid out in the standard ways, are then in the format required by the standard level 3 BLAS modules.

(5) Along this line, the present invention also provides the ability to avoid using ScaLapack PBLAS (Parallel BLAS). This capability means that PBLAS software can be, if desired, totally avoided in the parallel processing environment because the atomic blocks of data of the present invention can be processed on each process by just using conventional BLAS software modules. It also means that the atomic blocks of contiguous data of the present invention can be used in appropriately modified PBLAS software modules.

(6) The present invention again exhibits or demonstrates the matrix multiply dominance that occurs in DLAFA algorithms (the O(N**3) part of these algorithms) via the introduction of the Schur Complement Update. It is noted that this capability of the present invention is related to the discussion of several of the commonly-assigned applications mentioned in this section.

In the present invention, similar to the discussion in various of these applications, the C operands do not move on the processor. The blocks that move are the A and B operands. Also, the present invention incorporates send/receive buffers as an integral part of the algorithm, so that the operands that move do not have to be additionally reformatted and/or transported elsewhere. Therefore, the introduction of these buffers around the periphery of the algorithm data in local memory of each processor in the processor mesh eliminates the repeated copying of conventional methods.

Another significant feature of the present invention is that use of the atomic data blocks allow each processor in the processor mesh to have approximately the same number of blocks, thereby balancing the processing load throughout the processor mesh.

(7) The use of two representations of A. That is, A represents A^{T} and A^{T} represents A via the relationship (A^{T})^{T}=A. The practical significance of this feature is that the atomic data blocks can be stored in either rows or columns of data and then converted into their transposed format for processing if necessary or convenient in the processor grid. Moreover, by being square, the transposition can be done in-place.

It is noted that the concept of treating the atomic data blocks of the present invention, particularly when viewed as square-shaped, as units for manipulation in processing, such as forming the transpose of matrix data, can be considered as an extension into the parallel-processing environment of concepts taught in commonly-assigned application having Attorney Docket YOR920040314US1 “METHOD AND STRUCTURE FOR CACHE AWARE TRANSPOSITION VIA RECTANGULAR SUBSECTIONS”, U.S. patent application Ser. No. 11/035,033.

(8) The hierarchical description of matrix layouts is extended “up” from register layouts to parallel layouts by the present invention. Various commonly-assigned applications have provided improvements for processing matrix data on a single processor in a manner somewhat related to aspects of the present invention. Examples are Attorney Docket YOR920030331US1 “METHOD AND STRUCTURE FOR PRODUCING HIGH PERFOMANCE LINEAR ALGEBRA ROUTINES USING STREAMING”, U.S. patent application Ser. No. 10/671,934, Attorney Docket YOR920030330US1 “METHOD AND STRUCTURE FOR PRODUCING HIGH PERFORMANCE LINEAR ALGEBRA ROUTINES USING A SELECTABLE ONE OF SIX POSSIBLE LEVEL 3 L1 KERNEL ROUTINES”, U.S. patent application Ser. No. 10/671,935, and Attorney Docket YOR920030170US1 “METHOD AND STRUCTURE FOR PRODUCING HIGH PERFORMANCE LINEAR ALGEBRA ROUTINES USING LEVEL 3 PREFETCHING FOR KERNEL ROUTINES”, U.S. patent application Ser. No. 10/671,889.

(9) The further discussion below of the processing related to the present invention demonstrates the dominance of matrix multiplication of DLAFA algorithms, as mentioned earlier in the background discussion, via the introduction of the Schur Complement Update.

(10) Distributed memory processing via a block cyclic layout of a global matrix AG onto a P by Q mesh of processors AL requires global to local (AG→SAL) and local to global (AL→AG) mappings. These mappings have both symbolic and numeric related parts. The present invention introduces small data structures (symbolic part of the mappings implying a one-time cost of production) with the view of reducing processing time on all local processors (numeric parts which are done repetitively) simultaneously. This concept is somewhat related to item (5) above.

A key idea of the present invention is to use square block storage (i.e., layout the order N global matrix A as a partitioned matrix where each submatrix is order NB by NB. The main paradigm is a rectangular P by Q mesh of processes. Also, the layout of A on this mesh is the standard block cyclic distribution.

In the present invention, this distribution has the parameter NB. So, letting N=NB*n, one gets A to be a block matrix of order n. That is, each element of block matrix A is a square submatrix of order NB. Note that P and Q are arbitrary integers which have nothing to do with n. This means that all the known algorithms that operate on block matrix A will treat each order NB block as an atomic unit. That is, these atomic blocks will be sent and received to the various P*Q processes in units of the atomic unit NB**2.

The square block storage of the present invention treats these atomic units as contiguous storage, whereas standard storage does not. Hence, there will usually be a large performance gain when one chooses a data structure appropriate for an algorithm. This solution of the present invention does not require the PBLAS, which has been characterized as having a cumbersome interface as well as relative poor performance. It is noted that ScaLapack uses the PBLAS.

In the place of PBLAS, the present invention uses the Schur complement update, which appears in almost all factorization algorithms. The implementation described herein requires only the standard uni-processor Level 3 BLAS, in particular GEMM. Based on the existence of good network topologies that exist for almost all P by Q meshes, the sending and receiving of he order NB blocks will be near optimal. This is the only other major component in all of the dense linear algorithms. The main component, of course, is the Schur complement update.

This update is a huge GEMM update on all P*Q processes that is done simultaneously with perfect load balance. Therefore, this main component is a parallel computation. Also, the standard uniprocessor factorization algorithms are modified so that almost all time spent in the factorization part of the algorithm is overlapped.

By going to square block storage, as demonstrated by the two exemplary embodiments discussed above, one can also devise minimal storage distributed memory algorithms for triangular and symmetric matrices.

Modifying Conventional Matrix Routines to Accommodate the Two Data Layout Embodiments

In this section is discussed an example of some modifications to existing linear algebra routines to accommodate the two embodiments of the present invention. The more difficult modification occurs for the second embodiment, since the T2 portion of data has been relocated relative to its original location in memory. In contrast, because the first embodiment retains the original data relationships, the systematic direct mapping of data blocks onto the processor grid permits the conventional routines to be used with minimal changes.

Therefore, the first embodiment, also referred to herein as the “packed array” format, has only minor processing modifications from conventional triangular/symmetric matrix routines that operate on only the lower triangular blocks but have carried along the upper blocks as well; also conventional format requires storage and data shuffling throughout the processing. Because of this characteristic of minor changes, the packed array embodiment provide the benefit of the use of existing software to write equivalent routines, while being fully storage efficient and getting better or equivalent performance.

For demonstration purposes only, the well-known Cholesky factorization algorithm will be used to exemplarily show how existing triangular/symmetric matrix routines would be modified. One of ordinary skill in the art, after taking this discussion as a whole, will be able to similarly modify other routines used for processing triangular/symmetric matrix data.

The Cholesky factorization expresses a symmetric matrix as the product of a triangular matrix and its transpose (e.g., A=L L′, where L is the lower triangular matrix and L′ denotes the transpose of L). The following algorithm coding gives a standard, column-oriented formulation for a matrix in which processing is done on single elements (e.g., the “element-wise version”). It should be noted that the present invention addresses the method of processing on a parallel-processor machine and that data is more typically processed by blocks (submatrices) rather than single elements.

Right Looking Cholesky Factorization Algorithm (Element-Wise Version):

```
do j = 0, n−1
  aⱼⱼ = \sqrt{aⱼⱼ}
  do i = j+1, n−1
    aⱼⱼ = aⱼⱼ/aⱼⱼ
  enddo
  do i = j+1, n−1
    aᵢᵢ = aᵢᵢ − aⱼⱼ·aⱼⱼ
    do k = i + 1, n−1
      aₖᵢ = aₖᵢ − aₖⱼ ·aₖᵢ
    enddo
  enddo
enddo
```

The outer loop in the above algorithm is over successive columns of matrix A. First, the pivot is formed by taking the square root of aⱼⱼ. The pivot column j is formed by scaling it by the reciprocal of the pivot. Last, the trailing matrix is modified by a rank one update of the current scaled pivot column.

The simplest implementation of the Cholesky factorization is generally known as the right-looking variant, a name deriving from the fact that in every stage of the algorithm, the bulk of the computation is due to the update of the part of matrix A to the right of the “current” or pivot column. The brief description in the paragraph above is that of the scalar version of the right-looking variant of the Cholesky factorization.

The block version of the right-looking algorithm, more typically used in parallel machines and the version of the Cholesky Algorithm used in explaining the processing modifications for the present invention, is now given. This version is oriented to the parallel-processing environment and the colon indexing is used for blocks (e.g., panels) of data, rather than individual elements of the matrix. It is noted that when the block version below has block size 1×1, it becomes equivalent to the element-wise version above such that a(j,j)=a(j,j)^{1/2}=The LAPACK subroutine and/or BLAS routine used is listed as the comment to the right in the coding below.

Right Looking Cholesky Factorization Algorithm (Block Version):

```
do j = 0, n−nb, nb
  factor a(j:j+nb−1,j:j+nb−1) ! LAPACK potrf
  do i = j + nb, n−nb, nb
      a(i:i+nb−1,j:j+nb−1) = a(i:i+nb−1, j:j+nb−1) ·
      a(j:j+nb−1, j:j+nb−1) ! BLAS: trsm
  end do
  do i = j +nb, n−nb, nb ! THE UPDATE PHASE
      a(i:i+nb−1,i:i+nb−1) −= a(i: i+nb−1,j:j+nb−1)·
      a(i:i+nb−1,j:j+nb−1) ! BLAS: syrk
      do k = i + nb, n−nb, nb
      a(k:k+nb−1, i:i+nb−1) −= a(k:k+nb−1, j:j+nb−1) ·
      a(k:k+nb−1,i:i+nb−1)^{T} ! BLAS: gemm
    end do
  end do
end do
```

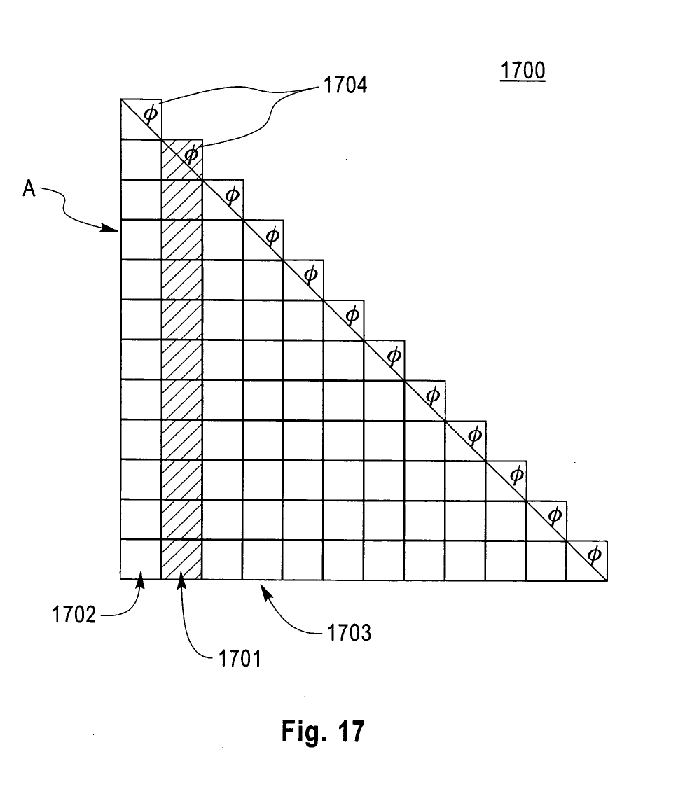

FIG. 17 provides a simplistic visual perspective 1700 of the Cholesky factorization process of the code above for matrix data A, as it proceeds from the left toward the right in a block column fashion. Columns 1702 to the left of the pivot column 1701 are complete. Columns 1703 to the right of the pivot column 1701 require updating with the currently factored block column.

Executing Cholesky Factorization for the Block Packed Format of the First Exemplary Embodiment

Returning again to FIG. 6, this figure shows the global view for an 18×18 lower triangular block matrix as containing only the essential data block packed format AGBP (e.g., matrix A Global Block Packed) for matrix A.

FIG. 7 shows the corresponding distribution on a P=5×Q=3 processor mesh of the matrix AGBP shown in FIG. 6, exemplarily for a BC condition for jp=3, to be understood with reference to the discussion below. It is noted that the upper case letters (e.g., J) represent the processors and the lower case letters (e.g., jp) represent the block indices.

Thus, p(I, J) will denote the process or processor at row I and column J of a processor mesh. We assume there are P process rows and Q process columns, so 0≦I<P and 0≦J<Q.

Lower case letters (e.g., i, j, k, l) denote indices or subscripts of the blocks that make up a given block matrix. There are both global indices and local indices. FIG. 6 depicts a global matrix AGB laid out in terms of its global indices. FIG. 16 shows AGB, but now each (i, j) element is on some p(I,J) of a P=5 by Q=3 mesh of processes.

Take, for example, p(1,2) which holds four border send receive buffers, (each a block vector) and a 4 by 3 block matrix surrounded by the four border vectors. These block vectors hold the A and B operands of GEMM. The elements of this 4 by 3 block matrix are certain sub matrices of AGB and their indices (global) indicate which elements of AGB (see FIG. 14) they are. However, to address these elements on p(1,2) we use local indices (il,jl) where 0≦il<mp=4 and 0≦jl<np=3. For example, (il,jl,I,J)=(1,1,1,2) is bl(5,5) of AGB of FIG. 14. FIG. 16 is the second embodiment layout of global matrix AGB.

Turning now to FIG. 7, this is the first embodiment layout of global matrix AGB. Here the local indices are given by a one dimensional addressing scheme plus a set of column pointers. For example, on p(1,2) there are five local columns (0:4) that have 3, 3, 2, 2, 1 blocks, respectively. These columns start at addresses 0, 3, 6, 8, 10, 11 of a vector (one dimensional) of blocks of length 11. Now, bl(9) on p(1,2) is the second block of column 3. This block is bl(b,b) of FIG. 14. Finally, there are just two border send buffers on the left and bottom borders of each process of the 5 by 3 mesh. These block vectors hold the A and B operands of GEMM.

In FIG. 7 the processes are considered as occurring on process rows identified from 0 to 4 and process columns identified from 0 to 2. The processor memory contents after the cyclic distribution is represented by the block numbers inside the square and the left column and lower row represent the send buffers for the processors. The asterisks (e.g., “*”) represent positions in which presently nothing is occurring. This figure represents the condition for which jp=3, wherein the columns on the left of each processor representing the send buffers are in receipt of a row BC from the zeroth process column (e.g., J=0). The lower rows of each processor grid are send receive buffers used for column broadcasts.

In general, the west and south boundaries in each process will hold the scaled pivot column blocks and element blocks residing to the north and east of these buffers will get updated.

The conventional right looking algorithm for execution by blocks of data can be summarized as: (here n1=N/NB)

```
Do j = 0 to n1−1
    Factor block a(j,j)
    Scale blocks a(j+1: n1−1,j) by block a(j,j)
    Update blocks a(j+1:n1−1,j+1:n1−1) using scaled blocks
    a(j+1:n1−1,j)
Enddo
```

In more detail, the above listed summary for the right looking algorithm can be executed as:

```
Do j = 0, n1−1
    Factor block a(j,j)  ! potrf
    Scale blocks a(j+1:n1−1) by block a(j,j)  !trsm
    Do i = j+1, n1−1
        a(i,i) −= a(i, j) ·a(i, j)^{t  ! syrk}
        Do k = i + 1, n1−1
            a(k,i) −= a(k,j) ·a(k, i)^{t  !gemm}
        enddo
    enddo
enddo
```

For the distributed memory version, after the AGBP is distributed onto a P by Q mesh in block cyclic fashion, the right looking algorithm is carried out with a slight modification, as follows:

```
Factor first column panel j = 0
Do j = 1, n1−1
    If p(0:P−1,J) does not hold the j-th pivot panel
        Receive scaled blocks cols j−1 in the W and S borders and
        use them to update all trailing blocks
    ElseIf p(0:P−1,J) holds the j-th pivot panel
        Receive scaled blocks cols of previous pivot col j−1 in the W
        and S borders
        Update the j-th pivot column panel, factor it, scale it and row
        BC the completed j-th pivot column panel
        Update the remaining trailing blocks of p(0:P−1,J) with the W
        and S borders (holding scaled column panel j−1)
    Endif
Enddo
```

For factoring a pivot panel, the following steps are executed:

p(0:P−1,J) updates the pivot col j with their W, S borders
(scaled column panel j−1)
p(I,J) sends pivot block (j,j) to all p(0:P−1,J)
p(0:P−1,J) factors pivot block (j,j) and scales the pivot col (j+1: n1−1,j)
(scaled column panel j)
p(0:P−1,J) row BCs the scaled pivot column (j+1:n1−1,j)

The details of the Send and Receives are as follows:

```
The SPB (scaled pivot blocks) (j+1:n1−1,j) are row BC;
The row of processes p(I,0:Q−1) receives all scaled blocks;
    A block (i, j) is column BC when it reaches p(I,K) that is holding
    block(i,i);
Row BC of block (i,j) stops at p(I,K) holding block (i,i) if i < j+q−1;
(Pictorially, here, “stopping” means that a broadcast BC is not done
to p(I,K+1), as it would hold non existent block (i,i+1))
Col BC of block (i ,j) stops at p(L,K) holding block (n1−1, i) if i+p ≧ n1.
(Pictorially, here, “stopping” means that a BC is not done to p(L+1, K),
as it would hold non existent block (n1,i).
```

For the update of the trailing matrix:

```
Do for all p(0:P−1,J), 0 ≦ J < Q.
    Receive row and col BC scaled pivot col blocks (j+1: n1−1,j) on the
    W and S borders.
    Do SYRK and GEMM updates on all trailing blocks
    (j+1, n1−1, j+1, n1−1),
    using the scaled pivot col blocks (j+1:n1−1,j) on the W and
    S borders.
Enddo
```

As previously mentioned, processing using the first embodiment differs from the processing of the conventional method in that the elimination of the superfluous data in the present invention and, using the block distribution as described, the blocks are contiguous, thereby eliminating the copying and management required in the conventional method.

Executing Cholesky Factorization for the Hybrid Full-Packed Format of the Second Exemplary Embodiment

Returning now to FIG. 13, which shows the hybrid full-packed rectangular data structure 1300, it should be apparent that the Cholesky factorization will require some modification from the triangular matrix data shown in FIG. 17, since the upper portion of the hybrid full-packed data structure 1300 includes the relocated triangular portion T2. It should be apparent that the pivot column 1303 will have blocks in S and T1 that proceed as in the process shown in FIG. 17 and that the upper blocks for portion of translated reflected upper T2 will have to be treated during processing as if they were being processed for the triangular portion T2. Again, it is noted that T1 and T2 would typically be padded with zeroes 1302, 1704 to allow data blocks to be generated at the interface that contain data from only the appropriate triangular portions.

Therefore, using the view from FIG. 13, in accordance with modification of the present invention, the conventional Cholesky factoring will be done in two parts when using the hybrid full-packed data structure, as follows:

```
- Part 1 [for columns 0 to n1−1 (e.g., to cover data portions S and T1 and
update T2)]
  Right-looking factorization of the block column consisting of T1 and S
  Update the trailing matrix in three parts:
    - syrk and gemm on T1;
    - gemm on S
    - syrk and gemm on T2
- Part 2: [for columns n1 to n−1 (i.e., to cover data portion for T2)]
  Right-looking factorization of T2
```

An exemplary coding that accomplishes the above summary is presented below. In the following, “bl” stands for block, “col” stands for column, “BC” stands for broadcast.

```
jp = 0
set pointers is, js, pr, pc for locating bl(jp,jp)
if (MYC = pc) then
  factor and scale bl col jp
  BC b 1 col jp for (MYR ≠ pr) and RCVE (bl col jp)
else
  RCVE bl col jp
Endif
Do jp = 1, n−1
  Set pointers is, js, pr, pc for locating bl(jp,jp)
    If (MYC = pc) then
      Update bl piv col (jp) using received bl piv col (jp−1)
      Factor and scale bl piv col(jp)
      BC bl piv col (jp) and for (MYR ≠ pr) RCVE bl piv col (jp)
      Update remaining trailing matrix using bl piv col (jp−1)
    Else
      Update trailing matrix using bl piv col(jp−1)
      RCVE bl piv col (jp)
    End if
End do
```

Preliminary Remarks About the Two Embodiments

FIG. 6 shows the block pack matrix AGBP of order n=18. It will be laid out on a P by Q processor mesh, where P=5 and Q=3. In the three left columns, we give the mesh R(ow) label, local row label, and global row label of the n rows of AGBP (letters a, b to h stand for 10, 11 to 17). These row labels are the row indices of the NT=n(n+1)/2=171 NB by NB blocks making up AGBP. The last three rows give global column labels, local column labels, and mesh column labels of the column indices of AGBP.

FIG. 14 shows data from FIG. 6 where we have taken rows and columns n1 to n−1 (=9 to h) of AGBP (matrix T2) and reflected it along its main diagonal. However, the individual blocks themselves are not transposed. Thus, this is not a true transpose. Because of symmetry the n1 by n1 upper triangular matrix T2 also contains the same information as does the original lower triangular matrix T2. We call both matrices T2 and to distinguish between them we reverse their block labels; ie, (i,j) with i≧j becomes (j,i).

We now translate upper triangular T2 to the top row of AGBP to get FIG. 15. In FIG. 15 matrix AGB has nr=n+1=19 rows and nc=9 columns. Note that AGB has the same NT=nr*nc=171 blocks. However, matrix AGB is rectangular. Recall that it consists of three pieces T1 of order n1, S of size n2 by n1 and T2 of order n2. In FIG. 16 we give FIG. 15 block cyclic layout on the P by Q mesh. This helps to explain why in FIG. 15 we have added two additional label sets on the E and N borders.

These labels refer to the upper triangular T2 block indices. The W and S borders, of course, refer to the T1 and S block indices. Return now to FIG. 15. Again note that every process of the P by Q mesh has four borders. These borders will hold scaled pivot blocks SPB that are sufficient to perform GEMM and SYRK updates. The W and S borders of FIG. 15 will hold SPB to handle T1 and S updates while the E and N border will hold SPB to handle upper triangular T2 updates.

In FIG. 7 we give the block packed cyclic layout of FIG. 6. Note here that we directly map AGBP onto the P by Q process mesh. It turns out that we only need the W and S buffers to hold the SPB blocks. In FIG. 7 these two borders are labeled with the jp=3 SPB blocks of AGBP (jp+1:n−1,jp). There are n−jp−1=14 blocks. The jp=3 pivot column J=0 lies on p(0:4,J) and the pivot block (jp,jp) is on p(3,J). These SPB blocks reside on local column jl=1 of p(0:4,J). Later, we shall describe in general how AGBP (jp+1:n−1,jp) is broadcast from p(0:P−1,J) to all SPB buffers on p(0:P−1, 0:Q−1).

The process is the same for FIG. 16. Here the two buffer sets (W,S) and (E,N) are filled with jp=0 SPB blocks of AGBP(jp+1:n−1,jp). There are n−jp−1=17 blocks this time. The jp=0 pivot panel is on p(0:4,J), J=0 and the pivot block (jp,jp) is on p(I,J). These SPB blocks (pivot panel) reside on local columns jl=0 of p(0:P−1,J).

The Schur Complement Update

The Schur complement is another name for the blocks ABPG (jp+1,n−1,jp+1:n−1). These blocks are updated during the update phase. In our case, they are the GEMM and SYRK updates. Almost all of the floating point operations are done in this phase which has 100% parallelization.

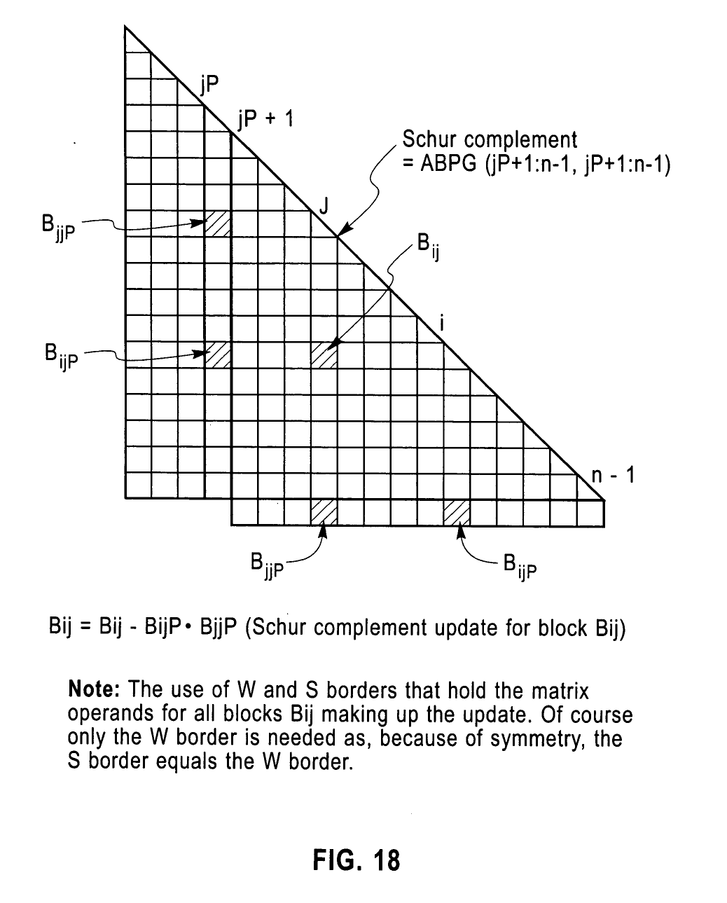

Looking at the FIG. 18, we see that blocks ABPG (jp+1:n−1,jp+1:n−1) are to be updated by the current scaled pivot blocks APBG (jp+1:n−1,jp). Let Bij be any Schur complement block and Bijp and Bjjp be its associated scaled pivot blocks. The update operation is Bij−=Bijp B^{T}jjp if the blocks are all in column major order.

We view FIG. 6 as being laid out in lower block packed format. FIG. 18 works directly here (i.e., Bij−=Bijp B^{T}jjp). In FIG. 14, Bij can be either a T1, S, or an upper triangular T2 block. The above formula works for the T1 and S blocks. For a T2 block, the formula is also the same as we have placed the original lower triangular T2 block there; ie, we have copied the corresponding lower triangular T2 block to its corresponding upper triangular block position but have not transposed it. The reason for this is to keep the GEMM and SYRK updates all the same. Now take FIGS. 15 and 16. Each p(I,J) has W and S borders that hold update operands Bijp and Bjjp. Here, jp<i<n=18 and jp<j<n1=9. These borders hold T1 and S update operands. Additionally, there are E and N borders that hold update operands Bijp and Bjjp. Here 9=n1≦i, j<n=18. In this example, we have set jp=0. The inactive elements in FIG. 16 are column 0 of AGBP. On each p(I,J) each active global bl(i,j) has two update operands present: if bl(i,j) is a T1 or S block its operands are found by projecting W and S; if bl(i,j) is a T2 block, its operands are found by projecting E and N. All that is necessary to update Bij are operands Bijp and Bjjp.

Now turn to FIG. 7. It depicts the block cyclic layouts of FIG. 6. Each p(I,J) has W and S borders that hold update operands Bjp and Bjjp. In FIG. 7, jp=3. The inactive blocks in FIG. 7 are all (i,j) for j<jp+1. Thus, global West i indices with i<4 and global South j indices with j<4 are inactive. For the time being, note that each active Schur complement block has two operands present for updating purposes (i.e., a W and S operand which is found by projecting W and S from its (i, j) position on p(I,J)). Therefore, in both embodiments, update of Bij requires operands Bijp and Bjjp.

We have assumed above that all NT blocks of AGBP have been stored in column major order. However, we can also store all of these blocks in row major order. In that case, each block is the transpose of the column major case and vice versa. This means we can use a transpose identity of GEMM; ie, C−=AB^{T} if and only if D−=E^{T}F where D, E, F are the transposes of C, B, A respectively. Here, we prefer to store the blocks in row major format because it will lead to the T,N form of GEMM as opposed to the N,T form of GEMM which one gets using column major order.

Details of Executing the Cholesky Factorization Process Using Embodiment 1

We shall give some further details about the lower Block Packed Cyclic algorithm. We shall not cover the upper case, as it is quite similar to the lower case. We now describe the mapping of a standard block (lower) packed array to our new block (lower) packed cyclic, a P by Q rectangular mesh, layout. Before doing so, we must define our new lower block pack cyclic LBPC layout on a rectangular mesh. The block order of our block packed global symmetric matrix ABPG is n. On a P by Q mesh, p(I,J) gets rows I+il·P, il=0, . . . , pe(I) and columns J+jl·Q, jl=0, . . . , qe(J). Here pe(I) and qe(J) stand for the end index values of il and jl. On the West border of p(I,J) we lay out pe(I)+1 send receive buffers and on the South border of p(I,J) we lay out qe(J)+1 send receive buffers. In FIG. 7, P=5, Q=3, n=18, pe(0:4)=4 4 4 3 3 and qe(0:2)=6 6 6.

Since ABPG can be viewed as a full matrix of order n, we could layout all n² blocks. However, we shall only layout the lower triangular blocks (e.g., just the blocks of ABPG). To do this, we use a column pointer array CP(0:np,0:P−1,0:Q−1), where np=(n+Q−1)/Q. On p(I,J), CP(jl,I,J) points to the first block of global column j=J+jl·Q. The column pointer array is found by counting the number of rows of column j that reside on p(I,J). It is clear that the last row of column j will have row index pl(I) independent of the column j and the process J. Using this fact and the nature of the standard block cyclic mapping, one can show that a row index array is not necessary. In FIG. 7, pl(I)=f,g,h,d,e.

To see this, note that C(jl,I,J) gives the first nonzero in column jl. The last index in column jl is pl(I) which is pointed at by CP(jl+1,I,J)−1. There are NU=CP(jl+1,I,J)−CP(jl,I,J) elements in column jl. Let il be the first global index in column jl. Then il=PL(I)−NU·P. The NU global indices in column j are il, il+P, . . . , PL(I). Hence, row indices are not required.

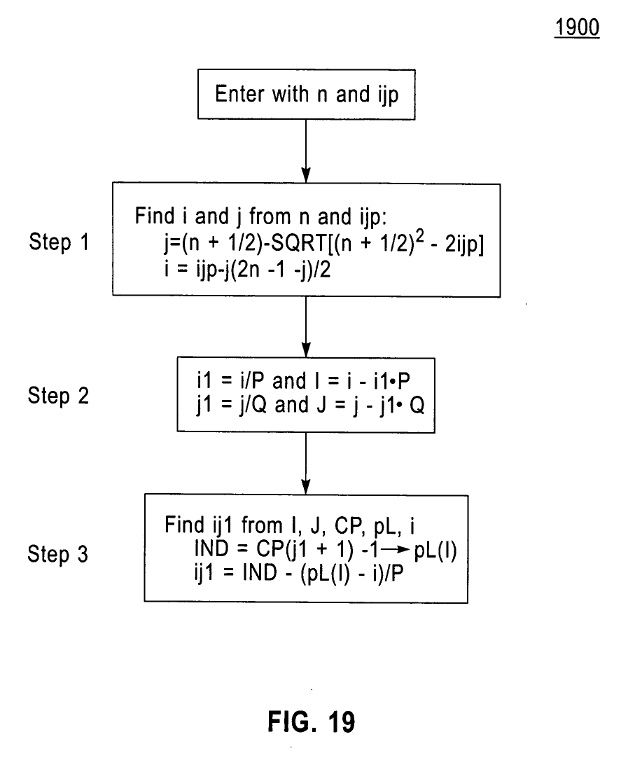

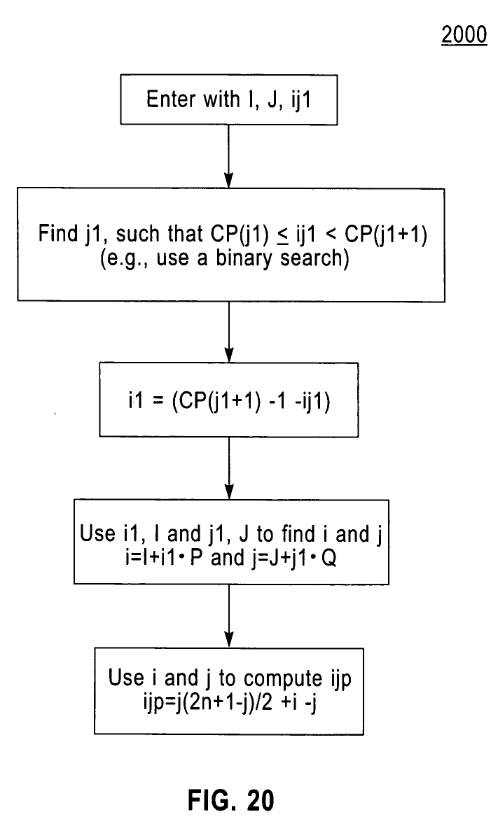

We can now define mapping glp (global local packed) and lgp (local global packed), which are flowcharted in FIGS. 19 and 20, respectively. For both mappings we assume the AGBP array is lower triangular. The idea behind describing both mappings is to move to full coordinates, use the standard full maps for gl (global local) and/or Ig (local global), and then move back to packed coordinates.

Looking now at the glp mapping shown in FIG. 19, we start with order n and 0≦ijp<NT=n(n+1)/2. From n and ijp we can compute global full coordinates i, j using the standard mapping from lower packed format to full format. Now we have i and j. The standard block cyclic mapping for a rectangular global array gives il=i/P and I=i−il·P and jl=j/Q and J=j−jl·Q. Now we have the full local coordinates. Using the properties of our LPBC layout, namely arrays CP, PL, we can find the unique ijl associated with I,J,jl, and i. See process box 3 of FIG. 19 for details.

Now look at FIG. 20 showing the lgp mapping. We start with I, J, and element ijl on P(I,J). From i,l, we need to find il, jl, the full coordinates associated with our LPBC layout. In process box 1, we can use a binary search to find jl, using input I,J,ijl and array CP. Knowing jl, ijl, and CP, we can find il (see process box 2). In process box 3, we use the standard block cyclic inverse mapping for a rectangle array to obtain the global i, j coordinates of AGBP. Finally, in process box 4, we compute ijp from i, j, using the standard map of full lower, L(i,j), to packed lower LP(ijp).

The first embodiment consists of three sub algorithms called (1) factor a panel jp producing n−jp−1 scaled pivot blocks (SPB's); (2) send and receive all SPB to all p(0:P−1,0:Q−1); (3) execute a Schur Complement Update on all p(0:P−1,0:Q−1). We now proceed to describe these three sub algorithms.

We now give details on factoring a pivot panel, as exemplarily implemented in the coding below.

```
Input j,J,pr,il,jl
CP(jl:jl+1,0:p−1,j,J), abpc(CP(jl,I,J):cp(jl+1,I,J)−1, 0:P−1,J)
I = pr
ijl = CP(jl,I,J) ! → bl(j,j) on P(I,J)
pb(I,J) = abpc(ijl, I, J) !pb is pivot send buffer on p(I,J)
DO NS BC from pb(I,J)
pb((I+1:I+P) modP,J) receives bl(j,j) ! bl(j,j) now resides on p(0:P−1,J0 in
pb(0:P−1,J)
DO i1=pr,pr+P−1
  I = mod(i1,P)
  call dpofu(pb(I,J),nb,nb,info) !pb is now factored
  ! scale all blocks below pivot block on p(I,J)
    ijl = cp(jl,I,J) !first block in column jl on P(I,J)
    if (il.eq.pr) ijl = ijl + 1 !bump ijl when I = pr
    ijpe = cp(jl+1, I,J) −1 ! last block to be scaled on p(I,J)
    DO ii = ijp,ijpe
      scale ABPC(ii,I,jj)
    enddo
  enddo
```

LBP Pivot Panel Factoring and Scaling Coding

We illustrate how this algorithm works. Referring to FIG. 7, we have jp=3=pr as the pivot panel and input to the coding above is:

J=0, pr=3, jl=1, cp(1:2,0,J)=4, 7, cp(1:2,1,J)=4,7, cp(1:2,2,J)=4,7, cp(1:2,3,J)=3, 6, cp(1:2,4,J)=3,6 and

apbc (4:6,0,J) bl(5,3), bl(10,3), bl(15,3); apbc(4:6,1,J) bl(6,3), bl(11,3), bl(16,3);

apbc(4:6,2,J) bl(7,3), bl(12,3), bl(17,3); apbc(3:5,3,J) bl(3,3),bl(8,3),bl(13,3);

apbc(3:5,4,J)=bl(4,3),bl(9,3) bl(14,3).

I=3

ijl=CP(1,3,J)=3 and apbc(3,3,0)=bl(3,3) the pivot pb(3,3)=bl(3,3) and a NS BC to P(0:2,J) and p(4,J) commences so that pb(0:2,J)=bl(3,3)=pb(4,J).

do il=3,3+4

il=3, I=3, factor pb(3,3), ijl=3, ijl=4, ijpe=5:

Scale blocks apbc(4:5,3,0)=bl(8,3) and bl(13,3)

il=4, I=4, factor pb(4,3), ijl=3, ijpe=5:

Scale blocks apbc(3:5,4,0)=bl(4,3), bl(9,3) and bl(14,3)

il=5, I=0, factor pb(0,3), ijl=4, ijpe=6:

Scale blocks apbc(4:6,0,0)=bl(5,3),bl(10,3) and bl(15,3)

il=6, I=1, factor pb(1,3), ijl=4, ijpe=6:

Scale blocks apbc (7:6,1,0)=bl(6,3),bl(11,3) and bl(16,3)

il=7, I=2, factor pb(2,3), ijl=4, ijpe=6:

Scale blocks apbc(4:6,2,0)=bl(7,3), bl(12,3), and bl(17,3)

After a pivot and scaling step completes a broadcast SEND RECEIVE commences on P(0:P−1,J). We now illustrate with explicit details how the SEND/RECEIVE algorithm, works on p(0:P−1,J), using the exemplary coding below.

```
input I,J,ils,jls,ijl
  ↓
Do il = ils to pe(I)
  i = I + il · P !global i
  slr = min(I−jp,Q−1) !length of WE BC
  ABPC(ijl) to r(il,I,J) ! bl(I,jp) to W send buffers
  DO E W BC from r(il,I,J)
  r(il,I,(J+1:J+slr)modQ) receive bl(i,jp)
  k = mod(i, Q) ! p(I,K) holds bl(i,j)
  jl = i/Q !C(jl,I,K) will hold bl(i,jp)
  slc = min(n−i,P)−1 !length of N S BC
  r(il,I,K) to c(jl,I,K) !bl(I,jp) to S send buffer
  DO N S BC from C(jl,I,K)
  C(jl,(I+1:I+slc)modP,K) receive bl(I,jp)
  ijl = ijl +1
enddo
```

LBP SEND/RECEIVE Algorithm Coding

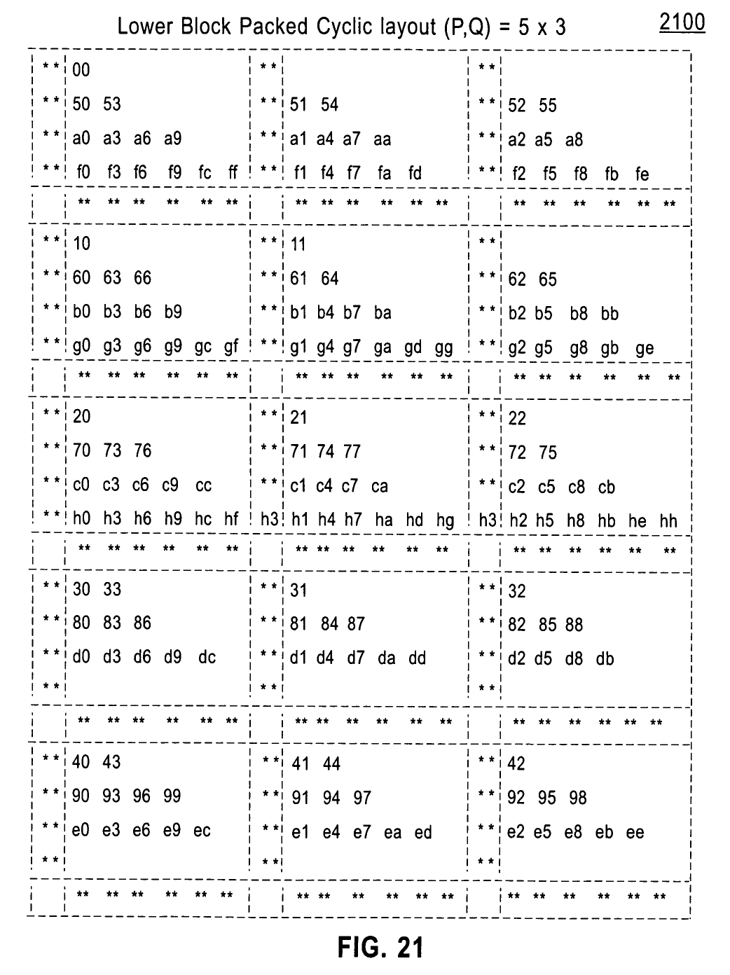

To illustrate the coding above, refer to FIG. 21. FIG. 21 shows all the W and S buffers empty. We have p(0:4,J), J=0 as the process column J holding the SPC AGBG(jp+1:n−1,jp) with jp=3. Here, the local coordinate jls associated with jp=3 has value 1. In the above coding, process I will take the values 0:4. We choose process I=4 as an example. Now, ils=0 and pe(I)=2. Also ijl=CP(jls, 4,3)=3. A DO loop il=ils to pe(I) commences:

il=0

i=4+0·p=4

slr=min (4−3,2)=1

ABPC(3,I,J) holds bl(4,3). It is copied to the West send buffer r(0,I,J) and an EW BC send of length sir commences.

P(1,1) receives r(0,I,J) in r(0,I,l). k=mod(4,Q)=1, so P(I,K) holds bl(i,i). Also jl=4/Q=1. Thus, r(0,I,K) is copied to S send buffer C(1,I,K). slc=min(18−4,P)−1=5−1=4. Now, a full NS BC commences and C(jl,0:3,K) receives bl(4,3) which is in buffer C(1,4,K). ijl=4, il=1, i=4+1·P=9, slr=min(9−3,2)=2. (a full row BC) ABPC(4,I,J), holding bl(9,3), is copied to W send buffer r(l,I,J).

A full E W BC commences. p(1,1:2) receives r(l,I,J) in r(il, I, l:Q−1), K=mod 9, Q)=0, so P(4,0) holds bl(i, i). Also jl=9/3=3. Thus, r(l,I,K) is copied to S send buffer C(3,I,K). slc=min(18−9,P)−1=4. A full N S BC commences and C(jl,0:3,K) receives bl(9,3) which is in buffer C(3,I,K)·ijl=5.

il=2, i=4+2·P=14, slr=min(14−3,Q−1)=2. (a full row BC) ABPC(5,I,J) holding bl(e,3) (e=14) is copied to W send buffer. r(2,I,J) and a full E W BC commences. P(1,1:2) receives r(2,I,J) in r(2,I,1:2)·K=mod(14,Q)=2 so P(4,2) holds bl(i,i). Also, jl=14/3=4. Thus, r(2,I,2) is copied to S send buffer C(4,I,K). scl=min(18−14,P)−1=3. A N S BC of length 3 commences and C(jl,0:2,K) receives bl(14,3) which is in buffer C(4,I,K).

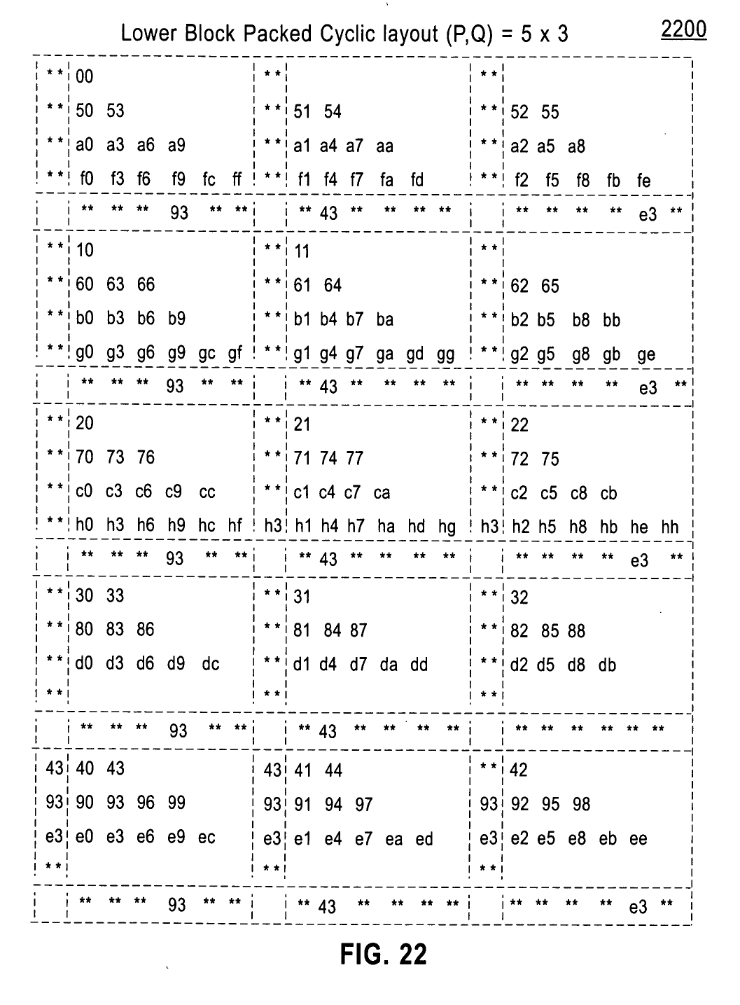

FIG. 22 shows what buffers were filled during the processing described above.

Finally, as FIG. 7 shows, one is ready for the Schur complement phase. The algorithm for doing this is given in the LBP UPDATE coding illustrated below.

```
      Input
jp I, J, jls j, jle(I,J), CP(0:jle(I,J)+1, I,J), pe(I)
abpc(CP(jls,I,S): CP(jle(I,J,)+1)−1,I,J) r(0:pe(I),I,J), c(jls:jle(I,J),I,J)
        ↓
DO jl = jls, jle(I,J)
  j − J + jl · Q ! global j · index
  ils = pe(I) + 1 − CP(jl+1,I,J) + CP(jl,I,J) ! local row start column jl
  i = I + ils · P !global i index
  ijp = cp(jl, I, J) ! → bl(i,j)
  if (i · gt · j) then ! gemm: bl(i,j) −= bl(i,jp) · bl(j, jp)^{t}
    abpc(ijP,I,J) −= r(ils,I,J) · c(jl,I,J) ^{t}
  else ! i=j, syrk: bl(i,i) −= bl(i,jp) · bl(i,jp)^{t}
    abpc (ijp,I,J) −= r(ils,I,J) · c(jl, I,J)^{t} ! r(lls,I,J) =c(jl,I,J)
  endif
  ijp = ijp + 1 ! bump abpc pointer
  do il = ils + 1, pe(i)
    abpc(ijp,I,J) −= r(ll,I,J) · c(jl,I,J)^{t} ! gemm
    ijp = ijp+ ! bump abpc poiter
  enddo
enddo
```

LBP UPDATE Coding

To illustrate this coding, consider p(I,J) of FIG. 7 with 1=4 and J=1. Other inputs are jp=3, jls=1, jle(I,J)=4, CP(0:5,I,J)=0 3 6 8 9 10, pe(I)=2, abpc (3:9, I,J)=bl(4,4), bl(9,4), bl(14,4), bl(9,7), bl(14,7), bl(14,10), bl(14,13), r(0:2,I,J)=bl(4,3), bl(9,3),bl(14,3) and c(1:4,I,J)=bl(4,3), bl(7,3), bl(10,3), bl(13,3).

do jl=1,4

jl=1, j=1+1·3=4, ils=3−6+3=0, i=4+0·5=4, ijp=3→bl(4,4) and c(l,I,J)=bl(4,3).

Since i=j, we do a syrk update: bl(4,4)−=bl(4,3)·bl(4,3)^{t} ijp becomes 4.

do il=1,2

il=1, abpc(4,I,J)=bl(9,4), r(l,I,J)=bl(9,3) and a gemm update bl(9,4)−=bl(9,3)·bl(4,3)^{t} is done. ijp becomes 5.

il=2, abpc (5,I,J)=bl(14,4), r(2,I,J)=bl(14,3) and a gemm update bl(14,4)−=bl(14,3)·bl(4,3)^{t} is done. ijp=6 and do loop on il finishes.

jl=2,j=1+2·3=7, ils=3−8+6=1, i=4+1·5=9 ijp=CP(2,I,J)=6 and i>j and a gemm update is to be done: apbc (6,I,J)=bl(9,7), c(2,I,J)=bl(7,3) and r(l,I,J)=bl(9,3).

So, bl(9,7)−=bl(9,3)·bl(7,3)ₜ and ijp becomes 7 and it now points at bl(14,7).

Do il=2,2 has one iteration.

il=2 r(2,I,J)=bl(14,3) and the gemm update is bl(14,7)−=bl(14,3)·bl(7,3)^{t} and ijp=8.

jl=3, j=1+3·3=10, ils=3−9+8=2, i=4+2·5=14, ijp=cp(3,I,J)=8 and i>j implying a gemm update: apbc (8,I,J)=bl(14,10), r(2,I,J)=bl(14,3), C(3,I,J)=bl(10,3) so bl(14,10)−=bl(14,3)·bl(10,3)ₜ is done and ijp becomes 9. Now DO il=3,2 is empty. jl=4, j=1+4·3=13, ils=3·10+9=2, i=4+2·5=14, ijp=cp(4,I,J).=9 and i>9 implies a gemm update: apbc(9;I,J)=bl(14,13), r(2,I,J)=bl(14,3), C(4,I,J)=bl(13,3) so bl(14,13)−=bl(14,3)·bl(13,3) is done and ijp becomes 10. Now DO il=3,2 is empty and DO il=1,4 is complete.

Details of Executing the Cholesky Factorization process Using Embodiment 2

We start with the mapping gl of AGB in FIG. 15 (for a general even n) to FIG. 16 which we call ARBC. AGB is the global array and ARBC is the AGB block cyclic layout on a P by Q mesh of processors. ARBC is the local array. To do so, we first define the mapping of a standard full block array to a standard block cyclic, a P by Q rectangular mesh, layout; i.e., global local (gl) and its inverse (lg). In FIG. 15 we add a fourth row and two fourth column labels to the North, West and East borders respectively. These additional labels are standard rectangular global indices associated the mesh R and mesh C indices. These additional labels aid in the construction of the mapping and inverse mapping between global and local indices relating AGBP (FIG. 14) to AGB (FIG. 15) to ARBC (FIG. 16).

Let 0≦I<P and 0≦J<Q. Given global coordinates 0≦ig<nr and 0≦jg<nc, we have il=ig/P, I=ig−il·P and jl=jg/Q, J=jg−jl·Q. Block (ig,jg) of AGB lies on P(I,J) at location (il,jl) of that process. For the inverse map, let I,J, il,jl be given; ie block (il,jl) of ARBC on P(I,J). This is block (ig,jg) of AGB, where ig=I+il·P and jg=J+jl·Q.

The above mapping is of help in defining the mapping gl and its inverse Ig for T1,S,T2. We assume that order n of ABPG is even. Then T1 and T2 are order n1=n/2=n2 and S is square of size n1 by n2. We will denote the global coordinates by (i,j) leaving off the suffix g. As above we reserved ig and jg for the nr=n+1 by nc=n1 rectangular matrix AGB.

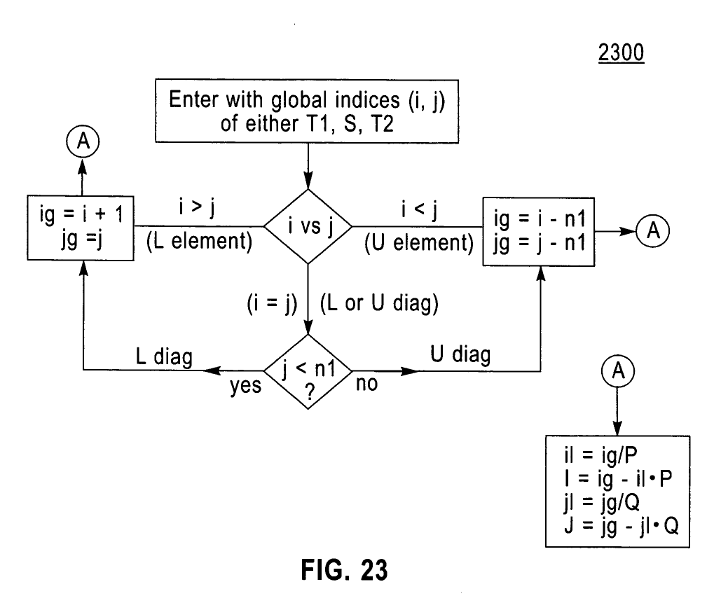

FIG. 23 describes the mapping gl. One starts with (i,j) coordinates of either T1, S, or T2. Depending on i,j values we compute ig,jg of the standard block cyclic layout. We then get to label A where we then find the local coordinates from (ig,jg). The final values (output) (I,J) (il,jl) tell us where element (i,j) resides on ARBC.

For FIGS. 15 and 16, we illustrate with elements (7,4), which is an element of T1, (c,6), which is an element of S, and (d,g), which is an element of T2. Element (7,4) maps to (ig,jg)=(8,4). This gives (il,jl)=p(1,1) on p(I,J)=p(3,1). Element (c,6) maps to (ig,jg)=(13,6). This gives (il,jl)=(2,2) on p(I,J)=p(3,0). Element (d,g) maps to (ig,jg)=(4,7). This gives (il,jl)=(0,2) on p(I,J)=p(4,1). Next, we turn to the inverse map 1 g T1,S,T2. We assume bl(I,j) is on P(I,J) at location (il,jl).

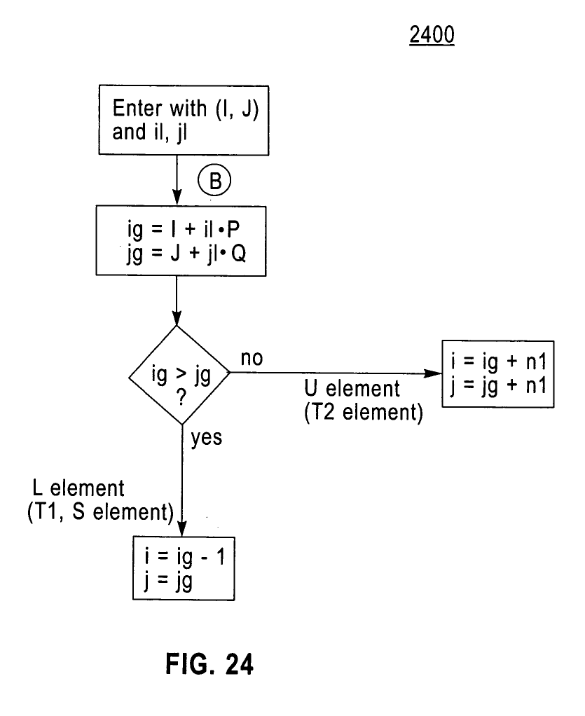

This being the case, we arrive at label B of FIG. 24. Using the standard inverse map, we find (ig,jg). The condition for an element to lie in the T2 region is ig≦jg. Thus, when ig>jg, we have a T1 or S element. In this case, i=ig−1 and j=jg. Finally, if i≧n1, then we have an S element; otherwise a T1 element.

We illustrate use of ig with element (I,J,il,jl)=(2,1,1,1), (4,2,2,2) and (1,1,0,0). Element (2,1,1,1) gives (ig,jg)=(7,4). Thus, (i,j)=(6,4). Element (4,2,2,2) gives (ig,jg)=(14,8). Thus, (i,j)=(13,8). Element (1,1,0,0) gives (ig,jg)=(1,1). Thus, (i,j)=(a,a).

We finish by illustrating a feature of FIG. 16. FIG. 16 shows a “picture” of the Cholesky algorithm operating on ARBC of FIG. 16. It shows the W S E N buffers full of matrix operands and thus is ready to perform Schur complement update. Previously, the SPB AGB(jp+1:n−1,jp) for jp=0 were computed. Also, they were BC from P(0:4,J) to W,S,E,N buffers and are shown, as such, in FIG. 16.

The second embodiment has two major parts: Factor AGB for 0≦jp<n1 and factor AGB for n1≦jp<n. Each of these two major parts consists of three sub algorithms called (1) factor a panel producing n−jp−1 scaled pivot blocks (SPB's); (2) send and receive all SPB to all p(0: P−1,0:Q−1); (3) execute a Schur Complement Update on all p(0:P−1,0:Q−1). We now proceed to describe these three sub algorithms for each of the two major parts.

Factor and Scale a Pivot Block 0≦j<n1

This case is like the first embodiment case. The pivot block factoring and scaling coding below implements the algorithm.

```
is, I j = I +1 + is ·P
js, J j = J + js ·Q
    ↓
pb(I,J) = arbc (is, js, I, J)
col BC pb(I,J) T1
to pb(K,J) K ≠I, 0 ≦K < P
For 0 ≦ K < P
  a) factor pb(K,J)
  b) scale all pivot blocks on P(K,J)
```

Coding for Factoring and Scaling a Pivot Block

We now describe the operation of the coding above for factoring and scaling of a Pivot Block. Let (is, js) be the local coordinates of pivot block bl(j,j) on p(I,J) where 0≦j<n1. We start on p(I,J) and given j we find (is,js). We then move to second and last process box of Figure A4. We copy bl(j,j) residing in arbc (is,js,I,J) to pivot buffer pb (I,J) and do a full column BC of pb(I,J) to receiving p(K,J), K≠1,0≦K<P. Then for 0≦K<P we factor pb(K,J) using dpotrf of LAPACK and scale all pivot blocks, bl(k,j), k>j, using level 3 BLAS dtrsm.

BC All SPB to All Processes, 0≦j<n1.

This is probably the most difficult sub algorithm to describe. Hence, some preliminary discussion is in order. We shall assume j=0 is the pivot column. This means the SRBs are bl(n−1,0) in FIG. 6 where n=18. These n−1 blocks are needed to update the trailing matrix agbp(1:n−1,i:n−1) of FIG. 6. We have already seen that bl(k,l) of agbp requires bl(k,j) and bl(l,j) from the SRB set in order to be updated. A bl(k,l) is T1 when j≦k, l<n1; is S when j≦l<n1 and n1≦k<n, and is T2 when n1≦k, l<n. Also it should be clear from FIG. 6 that bl(k, j) is needed to update bl(k,l), 1≦l≦k and bl(l,k), k+1≦l<n. One starts at row k and moves row-wise (East) to the diagonal bl(k,k). Then one moves column-wise down column k (South) to bl (n−1,k). It follows that T1 SRB blocks are only used to update T1 trailing blocks. And an S SRB block updates both S and T2 trailing blocks.

Now turning to FIG. 14, one can see that T1 SRBs travel a continuous path (k,j+1) row-wise to (k,k) followed by (k+1,k) column-wise to (n−1,k). S SRBs experience a discontinuity on reaching (k,n1−1). One might continue at bl(n1,k) of U and then travel column-wise (South) to diagonal bl(k,k) and then row-wise (East) to terminal block bl(k,n−1). It is noted that, by symmetry, this path is identical to the continuous path one would follow in FIG. 6.

However, given that one chooses to jump it is probably better to move to the diagonal bl(k,k). Reaching the diagonal gives one the opportunity to move along two paths: (k,k) to (n1−k,k) and (k,k) to (k,n−1). The best choice is to not jump at all. How can this be done? Usually, the row BC from p(I,J) of bl(i,j) will travel by all p(I,L), where 0≦L<Q. Thus, there exists an L and K such that p(K,L) holds bl (k,k). As seen above, we can move in both directions North and South and East and West to cover the remaining blocks of T2. In any case, this will be our strategy: on reaching process p(I,L) do a North path to reach bl(n1,k) on p(0,L) and a South path to reach bl(k,k) on p(K,L). Also, on reaching p(K,L) one does a second row BC to cover the path (k,k) to (k,n−1).

Now we return to a T1 SPB bl(i,j) where j<k<n1 and bl(i,j) is on p(I,J). There exist L such that bl(i,i) is on p(I,L). We do a row BC of length slr=min(i−j,Q)−1 and we claim that we must reach p(I,L) along the way.

First, we note that slr≧Q−1 is the usual case and slr<Q−1 is a rare event case. In FIG. 6, with j=0, bl(1,0) has slr=1, while blocks (2:8,0) have slr≧2. The usual case corresponds to a full BC. An aside: Any full BC offers the possibility of doing a two-way BC on most processors; eg, those of a toroidal design. On such processors a full BC runs at twice the speed. Here we do both an East and West BC and “meet in the middle”. Each BC has less than half the length equal to (Q−1)/2 where Q is odd. If Q is even, then one BC of half the length Q/2 while the other has length Q/2−1.

We return to our assertion that p(I,L) is visited. We need only show this when slr<Q−1. The row BC (West) travels the path (i,j+1) to (i,i). p(I,L) holds bl(i,i) by definition of L. Hence, since the path holds (i,i), we must visit the process p(I,L) holding bl(i,i). On p(I,L) we copy bl(i,j) from its west buffer w(il,I,L) to its south buffer s(jl,I,L). Then a column BC of length slc=min (n−i, P)−1 commences to reach all blocks in the path (i,i) to (n−1,i) that lie on process column L.

Now, we give some analytic details on an S SPB as we describe how to move S to all processes on which it is needed. Let bl(i,j) be an S SPB. We have n1≦i<n, 0≦j<n1; let il=i−n1. bl (i,j) in on p(I,J) Using map gl we have il=(i+1)/P, I=(i+1)−il·P; jl=j/Q, J=j−jl·Q. Also, using gl we find bl(i,i) of U is bl(kl,ll) on P(K,L) where kl=il/P, K=il−kl·P and ll=il/Q, L=il−ll·Q. Now K−I is congruent to (n1+1) mod P and L−J is congruent to n1 mod Q. Usually, n1>>Q. However, there is a small interval n1−Q<j<n1 in which the first West BC of bl(i,j) (from (i,j) to (i,n1−1)) has slr=min(n1−j, Q)−1<Q−1. In this rare event, we may find that the first West BC does not visit p(I,L).

Let ix=mod (il−j,Q). Next, if (ix>Q/2) then set ix=ix−Q; ie, ix is the minimum absolute modulus of Q. In these cases only, we extend the BC westward by length ix to reach p(I,L) when ix>0 or we do an additional BC eastward of length −ix to reach p(I,L). In summary, the purpose of the first West BC from p(I,J) is to visit blocks (j+1: n1−1, j) west of bl(i,j) and additionally to send bl(i,j) to p(I,L). Almost always, the first West BC from p(I,J) also visits (reaches) p(I,L).

Like a T1 SPB an S SPB has a column BC that emanates from p(I,L). The first row BC delivers bl(i,j) to p(I,L) receive buffer w(il,I,L). To initiate the col BC, one copies w(il,I,L) to no(ll,I,J) (we use no for north as variable n is being used to denote block order of AGBP) The length of the BC (path (n1,l) to (i,l)) is slc=min(il,P−1). This is a full BC when slc≧P−1, which is the usual case. In this usual case, we do both a northward BC (path (i,l) to (n1,l)) and a southward BC (path (i,l) to (1,1)).

We return to an S, SPB column BC of length slc. We have covered the usual case slc=P−1. To see this, note that il≧P−1 and a two way BC can be done. We go North: p(I,L) to P(0,L) and South: p(I,L) to p(p−1,L). We now describe the rare case slc<P−1. Let iy=mod (n1+1,P). If iy≧P/2, then set iy=iy−P; iy is the minimum absolute modulus of P. Distance iy is the “distance between processes I and K”. In our example, n1=9 and P=5. Now iy=0 and so I and K are always equal. This a lucky occurrence!

Note for P=5, iy=±2, ±1 or 0, depending on n1+1=±2+α·P, ±1+α·P, α·P, respectively, for some integer α. In our example, α=2. Recall slc=min(il−n1, P)−1. Thus, 0≦slc<P−1 when 0≦il<P−1. Thus, only the initial P−1 (“U blocks”) of S are rare blocks. They correspond to col BC lengths equal 0, 1, . . . , P−2. This case is analoguous to the rare ix case associated with the first row BC. From P(I,L), where bl(i,j) resides in w(il, I, J), we need to get bl(i,j) to either p(0,L) or p(K,L).

Suppose iy>0. Then for small il, I=K+iy. Since iy≦P/2, for il=0, (K=0), it is best to move N from 1 to 0, a send length slc=I. As il increases from 0, K increases and I moves closer to P. At some point, it will be better to move Southward from p(I, L) and to travel that way to reach p(K,L). This latter distance is slc=P−I+il. The switch over point occurs when I=P−I+il or when il+2iy=P. Now suppose il+2iy>P so that we should travel southwards and we do so until we reach I=0, which occurs when iI+iy=P. When this happens, slc=il and we do a one-way col BC from p(0,L) to p(K,L). Finally, if il+iy>P, we do a two-way col BC from p(I,L), I>0, of length min(il, P−1). As il is increasing we eventually get il=P−1 which was the usual case slc=P−1.

Suppose iy<0. Then for small il, I=P−iy+il; i.e., I≧P/2 but less than P. Thus, we travel from p(I,L) southward through 0 to K at p(il,L). The slc=P−I−il. Note that I increases at the same rate as il, so that here slc does not change as il increases. Eventually, I reaches 0. The processing at this point onward is identical to the iy>0 case. This finishes the complete description of the col BC which starts from p(I,L). Recall that the description had two parts, il≧P−1 and il<P−1. In both cases, bl(i,j) reaches p(K,L) in north buffer no(ll, K,L). Now, on reaching p(K,L), which holds bl(i,i), with bl(i,j) we transfer receiving buffer no(ll, k, L) to e(kl, K,L). Thus, e(kl, K, L) now holds bl (i,j). Finally, we are ready for the second row (west) BC from p(K,L) (path (i,i) to (n−1, i)) The second send length slr1=min (n1−il, Q)−1. Again, the usual case is a full row BC, which happens when slr1≧Q−1. When slr1<Q−1, a rare event, the BC is not full.

This finishes a complete description of sub algorithm BC all SPB to all processes. However, there are some interesting relationships between the two row BC. Note that S SPB blocks b(i,j), where n1≦i<n are the operands of the no and e buffers. For example, examine Figure δ and note that for every p(I,J) 0≦I<P and 0≦J<Q that S operands of the W buffer are identical to the S operands of the E buffer. This example is general and one can prove that when iy=0, that S operand of the W buffer equal the E operands. This tells us that the second row BC need not be done. Instead, for all 0≦I<P and 0≦J<P, we can copy these operands from the west S buffers to E buffers. More generally, for iy≠0, the E buffers of P(K,J)=the S W buffers of P(I,J) for 0≦J<Q, where I=(K+iy) mod P. We shall not prove this fact. However, we can use the result to give another algorithm for filling the East buffer: for iy≠0, p(I,J) sends its SW buffers to P(K, J) E buffers, where I=(K+iy) mod P.

The Schur Complement Update, 0≦j<n1

At this point in the algorithm, each of the West, South, East, and North send/receive buffers are filled with the T1 and S SPB blocks of pivot step j, where 0≦j<n1. Figure δ illustrates the update process when j=0. The pivot process column is p(0:4,J) where J=0. Note that local columns jl=0, corresponding to global column j=0, on p(0: 4;J) also contain the j+1: n−1 SPB. Currently, these 17 SPB are inactive. All remaining 153 blocks, bl(j+1: n−1, j+1:n−1), constitute the trailing matrix and they are to be Schur Complement updated by the various 17 SPB. Each p(I,J) contains L blocks (either T1 or S blocks) and U blocks (T2) blocks. The W and S buffers update L blocks and the E and N buffers update U blocks. We need a way to identify whether a given block of p(I,J) is L or U. And given that we have an L block, say, we need to know whether it is a diagonal block (requiring an SYRK update) or a non diagonal block (requiring a GEMM update). The same distinction is needed for a U block; ie. whether it is diagonal or off diagonal. If we know this information for bl(il,jl) of P(I,J) then the update is
bl(il,jl)−=w(il)·s(jl)^{T} syrk & L (i=j)
bl(il,jl)−=w(il)·s(jl)^{T} gemm & L (i>j)
bl(il,jl)−=e(il)·no(jl)^{T} syrk & U (i=j)
bl(il,jl)−=e(il)·no(jl)^{T} gemm & U (i<j)

We have suppressed the I,J dependence in the above four formulas. The information required is easily obtained by using the map lg. Using il, jl, I, J as input, we find i and j. Having i, j tells us that bl(il, jl) is a T1, S, or T2 block and whether this block is diagonal or not. The operation cost of this determination via map Ig is tiny (negligible) compared to the O(NB³) operations done by an syrk or gemm call. Still, it is not zero, and we shall describe a more efficient method.

We make a one-time computation of array jcs (0:np−1, 0:I−1, 0:J−1). This array gives the starting row index of L for local column jl, 0≦jl≦qe(j)j on P(I,J). The arrays pe(0:P−1,0:P−1,0:Q−1) and qe(0:Q−1, 0:P−1,0: Q−1) tell us the last local row and column index on p(I,J). They are identical for all 0≦I<P and 0≦J<Q.

In Table A1 below we give pe, qe, and jcs for our example problem of FIG. 16. On P(I,J), all L blocks in column jl occupy locations ARBC (jcs(jl): pe(I), jl, I, J) and all U blocks in column jl occupy locations ARCB (0:jcs(jl)−1, jl, I, J). Furthermore, any diagonal blocks of L and U in local column jl can only occur at local row positions jc(jl, I, J) and jc(jl, I, J)−1, respectively. And the number of diagonal block is n−j−1, whereas the number of gemm blocks is (n−j−2)(n−j−1)/2. So, we only use map lg np−jl times to distinguish if an L block on p(I,J) is diagonal or not and np times if a U block is diagonal or not. The update of the L blocks is followed by the update of U blocks.

Below we give their algorithms on p(I,J) and they are based on the above textual descriptions given above (e.g., see the exemplary coding below for L Schur Complement Update Coding and for U Schur Complement Update Coding). The arrays pe(0:P−1,0:P−1,0:Q−1) and qe(0:Q−1,0:P−1,0:Q−1) tell us the last local row and column index on p(I,J). They are identical for all 0≦I<P and 0≦J<Q.

It will turn out that the algorithm for the U Schur Complement Update, below, works for both 0≦j<n1 and n1≦j<n. In both cases, the A and B operands of gemm reside in the E and N buffers, respectively. What is different in these two cases is the array ijsu. Array ijsu(0:1,0:P−1,0:Q−1) gives us the starting local coordinates (is,js) of array T2(U) on p(I,J) Note that ijsu does not change for 0≦j<n1 as the U update is over the FULL T2 array for all j. Hence, initially, there is a one-time computation cost of ijsu along with jcs. However, during n1≦j<n, ijsu must be updated (or changed) for each j. However, this change only occurs for the pivot row entry, pr, of ijsu, i.e., ijsu(0:1, pr, 0: Q−1). In Table A1 below, we give pe, qe, jcs;, and the initial ijsu for our example problem of FIG. 16.

TABLE A1

| pe = 3 3 3 3 2 | array jcs | | | | | array ijsu | | | | | | |
|---|---|---|---|---|---|---|---|---|---|---|---|---|
| qe = 2 2 2 | I | J | jl | (0:2) | | I | jl | (0:2) | | | | |
| | 0 | 0 | 1 | 1 | 2 | | 0 | | 1 | | 2 | |
| | 1 | 0 | 0 | 1 | 2 | 0 | 0 | 0 | 0 | 0 | 0 | 0 |
| | 2 | 0 | 0 | 1 | 1 | 1 | 0 | 1 | 0 | 0 | 0 | 0 |
| | 3 | 0 | 0 | 1 | 1 | 2 | 0 | 1 | 0 | 1 | 0 | 0 |
| | 4 | 0 | 0 | 0 | 1 | 3 | 0 | 1 | 0 | 1 | 0 | 1 |
| | 0 | 1 | 1 | 1 | 2 | 4 | 0 | 2 | 0 | 1 | 0 | 1 |
| | 1 | 1 | 1 | 1 | 2 | | | | | | | |
| | 2 | 1 | 0 | 1 | 2 | | | | | | | |
| | 3 | 1 | 0 | 1 | 1 | | | | | | | |
| | 4 | 1 | 0 | 1 | 1 | | | | | | | |
| | 0 | 2 | 1 | 2 | 2 | | | | | | | |
| | 1 | 2 | 1 | 1 | 2 | | | | | | | |
| | 2 | 2 | 1 | 1 | 2 | | | | | | | |
| | 3 | 2 | 0 | 1 | 2 | | | | | | | |
| | 4 | 2 | 0 | 1 | 1 | | | | | | | |

L Schur Complement Update Coding:

```
n = nr−1 ! n is even
is = (1 + jp)/p ! local i coordinate if bl(jp,jp)
pr = 1 + jp − is · p ! bl(jp,jp) is on p(pr,pc)
js = jp/q ! local j coordinate of bl(jp,jp)
pc = jp −js · q ! bl (jp, jp) i s on p(pr,pc)
do jl = pc + 1, pc + q
  j − mod (j1, q)
  jjs = js
  if (jl > q)jjs = js
  if (j1.gt.j) jjs = jjs + 1
  do il = pr + 1, pr + p
    i = mod (il, p)
  ! L update on p(I,J) starts at (jcs(jjs, I, J), jjs)
    do jl = jjs, qe(j) ! begin at j1 = jjs
      jg = j + jl ·q
      il = jcs (j1,i,j) ! begin at il = jcs(j1,I,J)
      ig = i + il· p−1 ! ( n is even)
      if (ig.gt.jg) then ! gemm case
        dgemm : c = c − a· b^{T}
          ac(il, jl,i,j) − = w(il,i,j) · s(jl,i,j)^{T}
      else ! syrk case
        dsyrk: c = c − a·b^{T}
        ac(il,jl,i,j) − = w(il,i,j) · s (jl,i,j)^{T}
      endif
      do il = jcs(jl,i,j) + 1, pe(i)
        dgemm : c = c − a·b^{T}
        ac(il,jl,i,j) − = w(il, i,j) · s (jl, i, j)^{T}
      enddo
    enddo
  enddo
enddo
```

U Schur Complement Update Coding

```
n = nr − 1 ! n is even
n1 = (n+1)/2
do j = 0, q−1
  do i = 0, p−1
    U update on p(I, J) starts at ijsu (0:1, I,J)
    do jl = ijsu(1, i, j), qe(j)
      jg = n1 + j + jl · q ! ( n is even)
      do il = ijsu (0, i, j), jcs(jl, i, j) −2
        dgemm: c = c − a· b^{T}
        ac (il, jl, i, j) − = e(il, i, j) · no(jl, i, j)^{T}
      enddo
      il = jcs (jl, i, j) −1 ! last U element of col jl on p(I,J)
      ig = n1 + i + il· p
      if (ig.lt.jg) then ! gemm case
        dgemm : c = c − a· b^{T}
        ac (il, jl, i, j) − = e(il, i, j) · no(jl, i, j)^{T}
      else ! syrk case
        dsyrk : c = c − a· a^{T}
        ac (il, jl, i, j) − = e (il, i, j) · no (jl,i, j)^{T}
      endif
    enddo
  enddo
enddo
```

The Case n1≦j<n:

We have just given, above, three sub algorithms, Factor and Scale a Pivot block, BC all SPB's to all processors and the Schur Complement Update on all processors when 0≦j<n1. The description of the algorithm will be complete when we cover these three sub algorithms for the final n1 pivot steps n1≦j<n, which is done in this section.

At this juncture, T1 has been factored; i.e., it is in its final form. Likewise S has been scaled and is in its final form. T2 has been updated; all that needs to be done is to factor T2. Now recall that T2 is treated as being upper triangular whereas T1 is lower triangular. Embedded in the three previous sub algorithms we have an algorithm for factoring T1. We will change the three sub algorithm pieces relating to T1 so that they apply to reflected T1. Since reflected T1 is upper triangular, this will give us our algorithm for factoring T2. The basic change is to treat each row operation as a column operation and each column operation as a row operation.

Factor and Scale a Pivot Block Row n1≦j<n:

```
is, I j− n1 = I + is· P
js, J j− n1 = J + js · Q
    ↓
pb(I,J) = arbc(is, js, I, J)
row BC pb(I,J) of length slr = min(n−j,Q) − 1
to p(pr, mod(J+1: J+slr,Q))
For K = mod(J+1: J + slr, Q)
  a) factor pb (I,K)
  b) scale all pivot blocks on P(I,K)
```

We describe the coding above for the pivot block factoring and scaling. Let (is, js) be the local coordinate of pivot block (j,j) on p(I,J) where n1≦j<n. We start on P(I,J) and given j we find (is, js). We then move to the second process block of the coding. We copy bl(j,j) residing in arbc (is, is, I, J) to pivot buffer pb(I, J) and do a row BC (of pb(I,J)) of length slr=min (n−j, Q)−1 to p(pr, mod(J+1: J+slr, Q)). Then, for p(I,K) on which pb (I,J) is received, we factor pb(I,K) using dpotrf of LaPack and scale all pivot row blocks, bl(j,k) k>j, using level 3 BLAS dtrsm.

Algorithm BC All SPB to All Processes, n1≦j<n

This code is very similar to T1 BC as we want, for T2, to do a T1 BC of T1^{T}. Thus, let bl(j,i) be T2 SPC where j<i<n and bl(j,i) is on P(J,I) for some 0≦I<Q. Here, J=(j−n1) mod Q. There exists K such that bl(1,1) is on P(K,I) as, by definition, we are doing a col BC from P(J,I) to P(K,I) to reach bl(i,i). Here, K=(i−n1) mod P. The col BC is initiated by copying bl(j,i), located in ac(iL,jL, J,I), to North buffer no(jL,J,I). Here, iL and jL are the local coordinates of bl(j,k) on P(J,I). The send length slc=min(i−j, P)−1. On reaching the North buffer on p(K,I), bl(j,i) is in no(jL,K,I) and it is copied to east buffer e(ill,K,I) where iLl=(i−n1)/P. A row BC of length slr=min(n−i,q)−1 commences to reach all blocks in the path (i,i) to (n−1,i). This row BC is the analog of the col BC for the T SPB BC.

Algorithm Schur Complement Update n1≦j<n

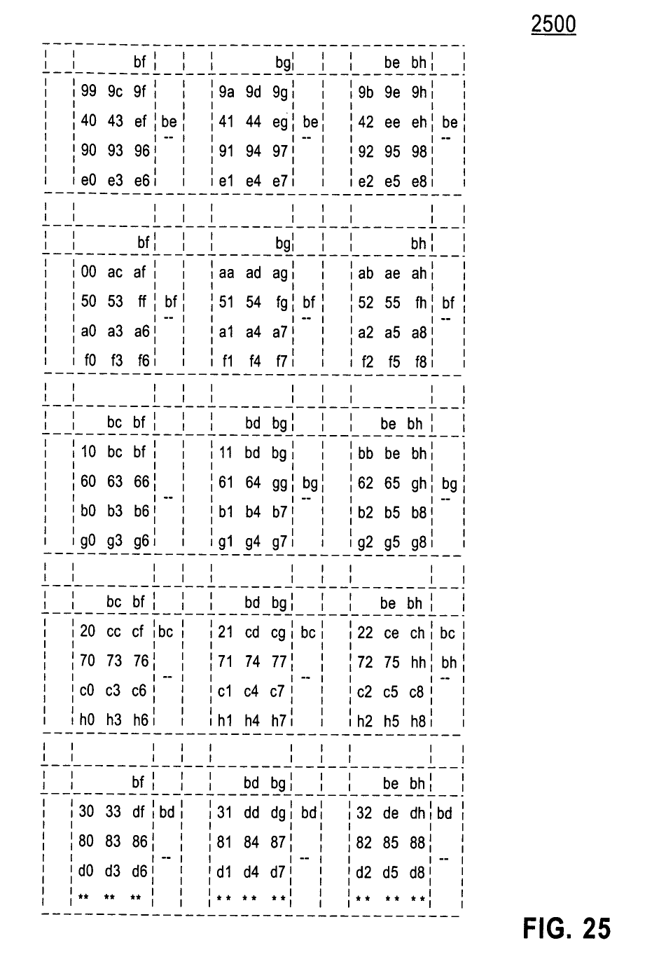

At this point, namely just after the BC of all SPB to all active processes, each east and north send/receive buffers are filled with T2 SPB blocks of pivot step j, where n1≦j<n. FIG. 25 illustrates the update process when j=11. The pivot process row is P(I,0:2) where I=2. Note that local rows il=0 corresponding to global row j=11 on p(1,0:2) also contains the j+1: n−1 APB. These six blocks, plus bl(j,j) on P(2,2) have just become inactive. During the previous 11 pivot steps 0:10, 143 other SPB have become inactive. The remaining 21 active blocks, bl(j+1, n−1, j+1: n−1) constitute the trailing matrix and they are to be Schur Complement updated by these various six SPB. (Note 143+7+21=171 blocks, which accounts for all nt=n(n+1)/2 blocks of AGB.) For n1≦j<n, only T2(U) blocks are active and as seen only E and N buffers are being used. Referring to the Schur Complement Update for 0≦j<n1, we see that we can use arrays jcs, pe, and qe. However, the starting local positions of the U elements are no longer fixed at j=0 values any more. Hence, we use a changing array ijsu to tell us where to start. In FIG. 25, the E and N buffers are filled with the SPB required for the U update. Note the array ijsu has changed in rows 0,1,2 (corresponding to pivots 9, 10, 11). See current ij su given in Table A2 below.

TABLE A2

| array ijsu | | | | | | |
|---|---|---|---|---|---|---|
| I | jl(0:2) | | | | | |
| | 0 | | 1 | | 2 | |
| 0 | 1 | 2 | 1 | 2 | 1 | 1 |
| 1 | 1 | 2 | 1 | 2 | 1 | 2 |
| 2 | 1 | 3 | 1 | 2 | 1 | 2 |
| 3 | 0 | 1 | 0 | 1 | 0 | 1 |
| 4 | 0 | 2 | 0 | 1 | 0 | 1 |

We now give a note of caution. Some care must be exercised in calling DGEMM and DSYRK. Recall that the T2 blocks are “transposed” to get the layout for FIG. 16. We are at liberty to store these blocks (from reflected T2) either in their original format or in transposed form (a true transpose). For example, in Table A2, Block ec could be original matrix ce, FIG. 25 or the transpose of the original matrix ce^{T}. Depending on what choice is made, the Schur complement of ec in the coding above for pivot block factoring and scaling, n1≦j<n, will take on different dgemm parameters.

Exemplary Hardware Implementation

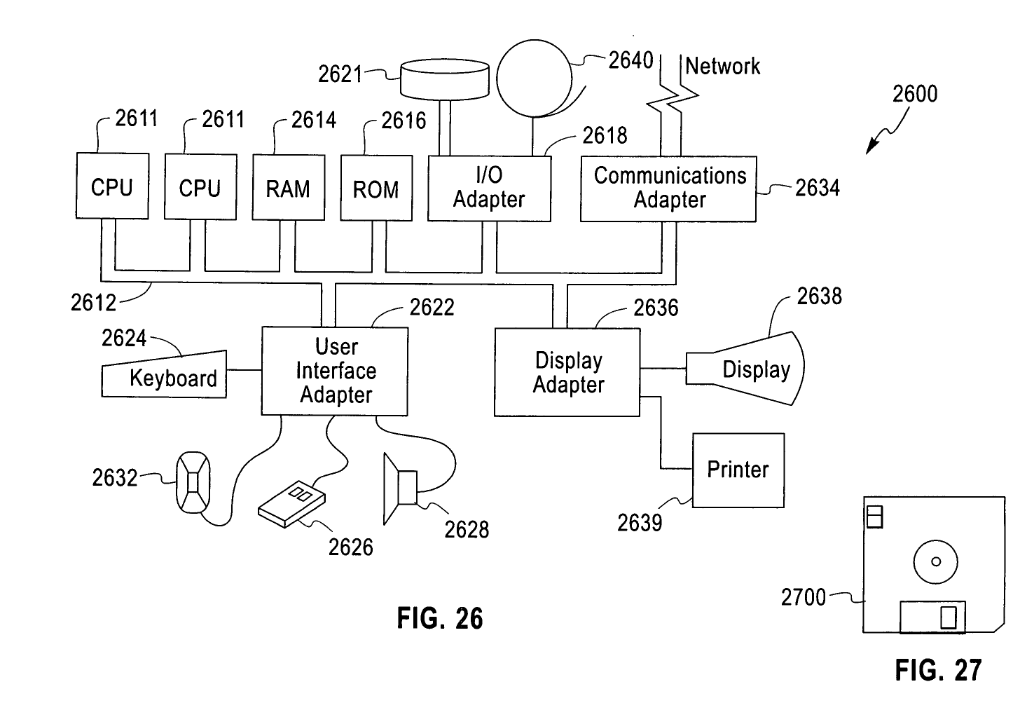

FIG. 26 illustrates a typical hardware configuration of an information handling/computer system in accordance with the invention and which preferably has at least one processor or central processing unit (CPU) 2611.

The CPUs 2611 are interconnected via a system bus 2612 to a random access memory (RAM) 2614, read-only memory (ROM) 2616, input/output (I/O) adapter 2618 (for connecting peripheral devices such as disk units 2621 and tape drives 2640 to the bus 2612), user interface adapter 2622 (for connecting a keyboard 2624, mouse 2626, speaker 2628, microphone 2632, and/or other user interface device to the bus 2612), a communication adapter 2634 for connecting an information handling system to a data processing network, the Internet, an Intranet, a personal area network (PAN), etc., and a display adapter 2636 for connecting the bus 2612 to a display device 2638 and/or printer 2639 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 2611 and hardware above, to perform the method of the invention.

This signal-bearing media may include, for example, a RAM contained within the CPU 2611, as represented by the fast-access storage for example. Alternatively, the instructions may be contained in another signal-bearing media, such as a magnetic data storage diskette 2700 (FIG. 27), directly or indirectly accessible by the CPU 2611.

Whether contained in the diskette 2700, the computer/CPU 2611, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

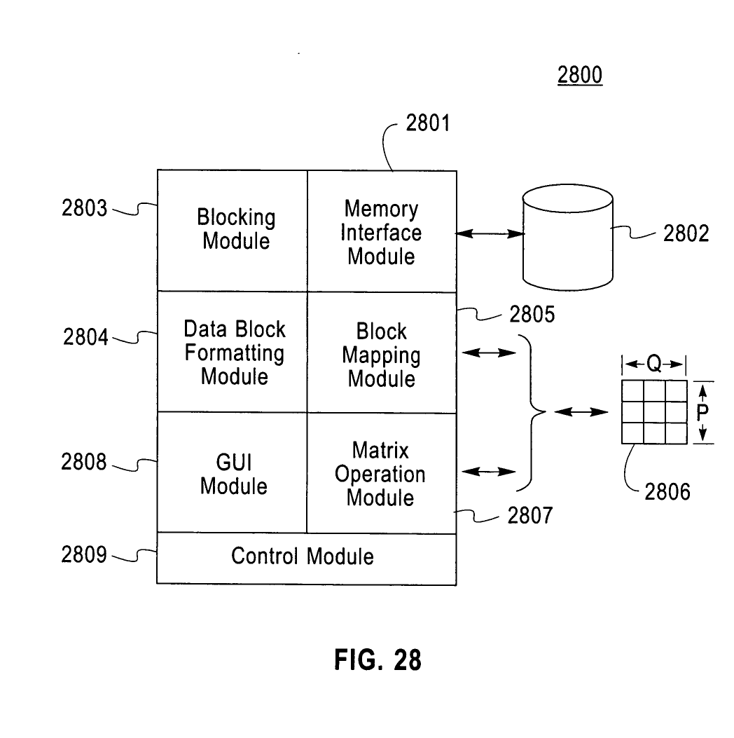

Along the same line as the signal-bearing media, the present invention can also be considered as a software tool that implements a matrix operation on a parallel-processor machine. FIG. 28 shows an exemplary generalized block diagram that shows the possible modules to be incorporated into such a tool 2800.

Memory interface module 2801 interfaces with matrix data stored in memory 2802. Blocking module 2803 organizes the matrix data into the atomic blocks of contiguous matrix data. Depending upon which of the two exemplary embodiments is to be executed, data block formatting module 2804 identifies the atomic blocks so that only those atomic blocks that contain essential data are marked for distribution to the processor mesh or further reorganizes the atomic blocks containing essential data into the hybrid full-packed data structure.

Mapping module 2805 distributes the atomic blocks of data onto the processor mesh 2806 and matrix operation module 2807 oversees the execution of the matrix operation, including, as required the downloading of instructions to each processor of the processor mesh 2806. Graphical user interface module 2808 allows for user inputs and display of information and data, and control module 2809 controls the overall operation of the tool 2800.

Discussing the software tool 2800 also raises the issue of general implementation of the present invention in a variety of ways.

For example, it should be apparent, after having read the discussion above that the present invention could be implemented by custom designing a computer in accordance with the principles of the present invention. For example, an operating system could be implemented in which linear algebra processing is executed using the principles of the present invention.

In a variation, as previously mentioned, the present invention could be implemented by modifying standard matrix processing modules, such as described by LAPACK, so as to be based on the principles of the present invention. Along these lines, each manufacturer could customize their BLAS or PBLAS subroutines in accordance with these principles.

It should also be recognized that other variations are possible, such as versions in which a higher level software module interfaces with existing linear algebra processing modules, such as a BLAS or other LAPACK module, are modified to incorporate the principles of the present invention.

Moreover, the principles and methods of the present invention could be embodied as a computerized tool stored on a memory device, such as independent diskette 800, that contains a series of matrix subroutines to solve scientific and engineering problems using matrix processing, as modified by the technique described above. The modified matrix subroutines could be stored in memory as part of a math library, as is well known in the art. Alternatively, the computerized tool might contain a higher level software module to interact with existing linear algebra processing modules.

It should also be obvious to one of skill in the art that the instructions for the technique described herein can be downloaded through a network interface from a remote storage facility.

All of these various embodiments are intended as included in the present invention, since the present invention should be appropriately viewed as a method to enhance the computation of matrix subroutines, as based upon recognizing how linear algebra processing can be more efficient by using the principles of the present invention.

In yet another aspect of the present invention, it should also be apparent to one of skill in the art that the principles of the present invention can be used in yet another environment in which parties indirectly take advantage of the present invention.

For example, it is understood that an end user desiring a solution of a scientific or engineering problem may undertake to directly use a computerized linear algebra processing method that incorporates the method of the present invention. Alternatively, the end user might desire that a second party provide the end user the desired solution to the problem by providing the results of a computerized linear algebra processing method that incorporates the method of the present invention. These results might be provided to the end user by a network transmission or even a hard copy printout of the results.

The present invention is intended to cover all these various methods of using the present invention, including the end user who uses the present invention indirectly by receiving the results of matrix processing done in accordance with the principles of the present invention.

That is, the present invention should appropriately be viewed as the concept that efficiency in the computation of matrix subroutines can be significantly improved on parallel-p-processor machines by treating matrix data as being atomic blocks of data distributed in a more or less balanced manner to a mesh of processorse, thereby allowing the processing to be executed by considering each atomic block of data as being the basic unit of the matrix processing.

This concept provides a generalized technique that improves performance for linear algebra routines in the parallel processor environment by virtually eliminating the extra storage requirement on the processor grid and the excessive copying and managing of data that plagues conventional methods of parallel processing.

Having thus described our invention, what we claim as new and desire to secure by Letters Patent is as follows:

1. A computerized method of linear algebra processing on a computer having a plurality of processors interconnected in a mesh for a parallel processing of data, said method comprising:
for a matrix data to be used in processing a matrix operation on said mesh of processors, organizing said matrix data into atomic blocks of data for distribution of said matrix data onto said mesh of processors for processing,
wherein at least one of said atomic blocks of data comprises an increment of said matrix data that is stored as an atomic block unit in a memory of at least one of said processors in said mesh of processors as being managed for processing as a unit of data during said matrix operation processing.

2. The computerized method of claim 1, wherein said at least one atomic block unit processed as a unit of data comprises contiguous data of said matrix data stored in said memory.

3. The computerized method of claim 1, further comprising:
distributing said atomic blocks of data onto said mesh of processors; and
executing said matrix operation on said mesh of processors in increments of said atomic blocks of data.

4. The method of claim 3, wherein:
said matrix data is originally stored in a memory in one of a triangular matrix format, a symmetric matrix format, and a rectangular matrix format; and
for any matrix data stored in said triangular matrix format or said symmetric matrix format, said distributing of said atomic blocks onto said mesh of processors is done such that substantially only essential data of said triangular matrix or said symmetric matrix is transferred from said memory to said processors for said processing, said essential data being data of said triangular matrix or said symmetric matrix that is minimally necessary for an information content of said triangular matrix or said symmetric matrix.

5. The method of claim 4, wherein said plurality of processors is considered to be arranged in a grid pattern, said distributing comprising a block cyclic pattern wherein said data is distributed to processors in said grid pattern in a block wrap-around manner.

6. The method of claim 4, wherein said distributing substantially only essential data to said plurality of processors comprises:
directly distributing said atomic blocks of triangular matrix format or said symmetric matrix format to said plurality of processors using a distribution mapping between said triangular matrix data or said symmetric matrix data stored in said memory to said plurality of processors, said distribution mapping selectively including only those atomic blocks that contain any of said essential data of said triangular matrix data or said symmetric matrix data.

7. The method of claim 4, wherein said distributing substantially only essential data to said plurality of processors further comprises:
preliminarily converting said atomic blocks of contiguous data of said matrix data originally stored in said triangular matrix format or said symmetric matrix format and that contain essential data into a substantially rectangular- or square-shaped data structure, said data structure thereinafter being distributed to said plurality of processors.

8. The method of claim 5, wherein one of:
columns of atomic blocks of said matrix data are transferred in a block cyclic distribution to columns of processors of said grid pattern in a block wrap-around manner; and
rows of atomic blocks of said matrix data are transferred in a block cyclic distribution to rows of processors of said grid pattern in a block wrap-around manner.

9. The method of claim 6, wherein said block cyclic distribution comprises a block cyclic block packed cyclic distribution, wherein a starting location in a column or row of processors for said wrap-around manner of distribution is determined based on a relation of a diagonal of said matrix data being distributed.

10. The method of claim 1, wherein:
a memory of each said processor in said mesh that receives said atomic blocks comprises send/receive buffers; and
atomic blocks of data are selectively placed in said send/receive buffers during said distribution.

11. The method of claim 1, wherein said method is used to one of solve and apply a scientific/engineering problem, said method further comprising at least one of:
providing a consultation for solving a scientific/engineering problem using said linear algebra software package;
transmitting a result of said linear algebra software package on at least one of a network, a signal-bearing medium containing machine-readable data representing said result, and a printed version representing said result;
receiving a result of said linear algebra software package on at least one of a network, a signal-bearing medium containing machine-readable data representing said result, and a printed version representing said result; and
developing a standard library software module that processes matrix data using said hybrid full packed data structure.

12. An apparatus for linear algebra processing, said apparatus comprising:
a plurality of processors for executing a parallel processing operation, at least one of said processors comprising a memory for storing data during said parallel processing operation; and
a main memory initially storing matrix data to be used in said linear algebra processing,
wherein said matrix data stored in said memory is organized into atomic blocks of matrix data for a distribution of said matrix data to said plurality of processors, at least one said atomic blocks to be managed for processing during said parallel processing operation as a unit of matrix data.

13. The apparatus of claim 12, wherein:
said memory of said at least one of said processors that receives said atomic blocks comprises send/receive buffers; and
atomic blocks of data are selectively placed in said send/receive buffers during said distribution.

14. A signal-bearing medium tangibly embodying a program of machine-readable instructions executable by a digital processing apparatus to perform a computerized method of linear algebra processing on a computer having a plurality of processors interconnected in a mesh for a parallel processing of data, each said processor comprising a memory for storing data during said parallel processing operation, said method comprising:
for a matrix data to be used in processing a matrix operation on said mesh of processors, organizing said matrix data into atomic blocks of data for a distribution of said matrix data onto said mesh of processors,
wherein at least one said atomic block comprises an increment of said matrix data that is managed during said matrix operation processing to be processed as a unit of data.

15. An apparatus for linear algebra processing, said apparatus comprising:
a plurality of processors for executing a parallel processing operation, at least one of said processors comprising a memory for storing data during said parallel processing operation;
a distributing module to distribute matrix data onto at least some of said plurality of processors; and
a data reformatting module so that said distributing matrix data, for any of a matrix having elements originally stored in a memory in one of a triangular matrix format and a symmetric matrix format, allows substantially only essential data of said triangular or symmetric matrix to be transferred to said processors for said processing, said essential data being data of said triangular or symmetric matrix that is minimally necessary for an information content of said triangular or symmetric matrix.

16. The apparatus of claim 15 wherein said plurality of processors is arranged in a grid pattern, said distributing comprising a cyclic pattern wherein said data is distributed to processors in said grid pattern in a wrap-around manner.

17. The apparatus of claim 15, wherein said distributing comprises a distribution in which blocks of contiguous data are distributed.

18. The apparatus of claim 15, said distributing substantially only essential data to said plurality of processors further comprising:
preliminarily converting said matrix elements originally stored in said triangular or symmetric matrix format into a substantially rectangular- or square-shaped data structure comprising said substantially only essential data,
said data structure thereinafter being distributed to said plurality of processors.

19. The apparatus of claim 15, said distributing substantially only essential data to said plurality of processors comprising:
directly transferring said elements originally stored in a memory in triangular or symmetric matrix format to said plurality of processors, said transferring comprising a transfer mapping directly between said triangular or symmetric matrix data stored in said memory to said plurality of processors, said transfer mapping selectively including only said substantially only essential data of said triangular or symmetric matrix data, said transfer mapping selectively not including substantially any of a remaining superfluous data of said triangular or symmetric matrix data.

20. The apparatus of claim 19, wherein said plurality of processors is arranged in a grid pattern, said distributing comprises a cyclic pattern wherein said data is distributed to processors in said grid pattern in a wrap-around manner, and a starting location in a column or row of processors for said wrap-around manner of distribution is determined based on a relation of a diagonal of said matrix data being distributed.
